(19) United States
(12) Patent Application Publication
(10) Pub. No.: US 2016/0169850 A1
(43) Pub. Date: Jun. 16, 2016

(54) SENSOR MOLECULE

(71) Applicant: University of Malta, Msida (MT)

(72) Inventors: David C. Magri, Msida (MT); Jake Spiteri, Mosta (MT)

(21) Appl. No.: 14/961,032

(22) Filed: Dec. 7, 2015

(30) Foreign Application Priority Data
Dec. 12, 2014 (GB) 1422176.6

(51) Int. Cl. G01N 31/22; C07F 17/02; G01N 21/64; G01N 21/77

(52) U.S. Cl. CPC G01N 31/221; G01N 21/77; C07F 17/02; G01N 21/6428; G01N 2021/7786

(57) ABSTRACT

The present invention relates to a method of measuring the acidity and redox potential of a sample, which method comprises:
(i) contacting a compound of formula (A) with the sample:

Acc(-L¹-)ₐFluo(-L²-)_{b}Redox (A);
wherein:
   Acc is a proton acceptor moiety;
   Fluo is a fluorophore;
   Redox is a redox unit;
   each L¹ is a first spacer group which is bonded to Acc and Fluo;
   each L² is a second spacer group which is bonded to Fluo and Redox;
   a is 1 or 2; and
   b is 1 or 2; and
(ii) exposing the sample to a light source, measuring fluorescence and thereby determining the acidity and redox potential of the sample.
   Compounds and the use of such compounds are also described.

### FIELD OF THE INVENTION

The present invention relates to a method of measuring acidity and redox potential of a sample. Compounds useful in a method of measuring acidity and redox potential of a sample are also described, as is the use of such compounds.

### BACKGROUND OF THE INVENTION

Sensing devices based on molecular logic gates have flourished in the last two decades and several new molecules with unique sensing properties have been synthesised. The term logic gate refers to a device that is able to easily read inputs and deliver outputs after performing a logical operation. Molecular logic gates are built from a collection of readily available chemical groups with known capabilities. Assembly of these groups in a single unit allows for the production of a molecular sensing device that operates via Boolean logic. Possible inputs include electronic, chemical, temperature and light stimuli. The inputs sensed induce a molecular change and finally an output signal such as photon emission, chemical reactions or electric potential changes can be detected and analysed.

One way in which an output from a molecular sensor may be detected is by measuring or observing fluorescence (or luminescence or phosphorescence). For such molecular sensors, a detecting moiety is attached to a fluorophore. Changes in the state of the detecting moiety affect the fluorescence of the fluorophore. pH sensors and redox potential sensors based on fluorescence are known. Typically, a change in state of the detecting moiety prevents photo-induced electron transfer (PET) from the detecting moiety to the fluorophore (or vice versa) which would otherwise quench the fluorescence. In the absence of the state change of the detecting moiety, PET will quench the fluorescence. Typically, for a moiety for detecting acidity, the state change will be protonation (or deprotonation) of the detecting moiety. In a moiety for detecting redox potential, the state change will be oxidation or reduction of the moiety.

An important application for molecular sensors and logic gates is the detection of acidity and redox potential. There has been interest in this area in relation to molecular sensors that can detect either the acidity (i.e. pH) or the redox potential (i.e. pE). In particular, compounds that can act as AND logic gates, and in relation to the presence of acidity and oxidation, can detect both properties simultaneously are desirable: this class of compound has been referred to as Pourbaix sensors. An idealised AND logic gate only produces the output (1) when the two inputs are also (1). If either or both of the inputs are (O) the output will also be (O). In the case of Pourbaix sensor molecules, this means that a significant output is observed only when both a certain level (threshold concentration) of acidity and a certain level (threshold concentration) of redox potential are present at the same time.

Pourbaix sensors, capable of acting as AND molecular logic gates, are known in relation to the two inputs of pH (acidity) and pE (redox potential). All known molecular Pourbaix sensors have adopted a modular design wherein a redox unit is attached to a proton accepting moiety by a spacer, and the proton acceptor moiety is attached to a fluorophore by a spacer (represented schematically as redox unit-spacer-proton acceptor-spacer-fluorophore). For instance, J. Gan, H, Tian et al., J. Organomet. Chem., 2002, 645, 168 describe compound 1 given below, although the idea of molecular Pourbaix sensors acting as AND logic gates is not discussed. The idea of Pourbaix sensors with the structure redox unit-spacer-proton acceptor-spacer-fluorophore explicitly state was developed in D. C. Magri, New J. Chem., 2009, 33, 457 (compound 2), T. J. Farrugia and D. C. Magri, New J. Chem., 2013, 37, 148 (compound 3) and D. C. Magri, M. Camilleri Fava, and C. J. Mallia, Chem. Commun., 2014, 50, 1009 (compound 4).

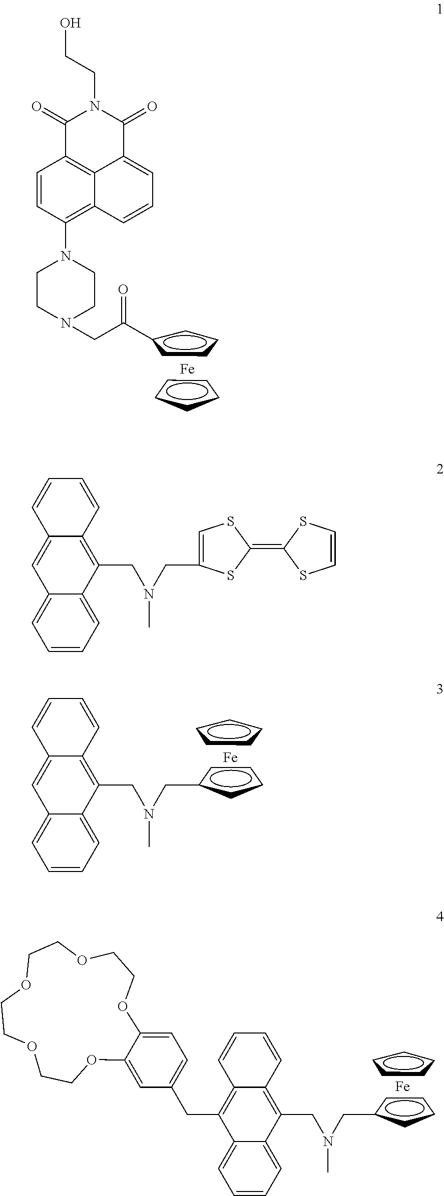

Liu et al. (Phys. Chem. Chem. Phys 2010, 12, 13026-13033) describe molecules containing platinum-based chromophores. Fluorescent molecules are not described. Chen-Jie Fang et al. (New J. Chem., 2007, 31, 580-586) and Wei Sun et al. (J. Phys. Chem. C 2008, 112, 16973-16983) describe compounds in which several units together act as a fluorophore.

Improvements in the design of chemical sensors capable of sensing both acidity and redox potential are still desirable. In particular, the development of methods of measuring acidity and redox potential using sensor molecules with water-solubility properties, a longer absorption and emissive wavelengths, a higher quantum yield of fluorescence and an enhanced switching ratio between the ‘off’ and ‘on’ states is sought.

### SUMMARY OF THE INVENTION

The inventors have found that by adopting the new modular design ‘receptor-spacer-fluorophore-spacer-redox unit’ for sensor molecules, novel and highly effective sensor molecules for a method of measuring acidity and redox potential are capable of acting as molecular AND logic gates. Significant improvements have been achieved in the fluorescence quantum yield output and fluorescent enhancement ratio of the compounds according to the invention compared to the known compounds 1-4. Furthermore, the AND logic output and quantum yield studies were demonstrated in aqueous solutions of 1:1 (v/v) methanol:water, an exception when compared to reported examples in the literature (which were demonstrated in non-aqueous solvents).

Thus, the invention provides a method of measuring the acidity and redox potential of a sample, which method comprises:
(i) contacting a compound of formula (A) with the sample:

Acc(-L¹-)ₐFluo(-L²-)_{b}Redox (A);
wherein:
   Acc is a proton acceptor moiety;
   Fluo is a fluorophore;
   Redox is a redox unit;
   each L¹ is a first spacer group which is bonded to Acc and Fluo;
   each L² is a second spacer group which is bonded to Fluo and Redox;
   a is 1 or 2; and
   b is 1 or 2; and
(ii) exposing the sample to a light source, measuring fluorescence and thereby determining the acidity and redox potential of the sample.

The invention also provides a compound of formula (A):

Acc(-L¹-)ₐFluo(-L²-)_{b}Redox (A);
wherein:
   Acc is a proton acceptor moiety;
   Fluo is a fluorophore;
   Redox is a redox unit;
   each L¹ is a first spacer group which is bonded to Acc and Fluo;
   each L² is a second spacer group which is bonded to Fluo and Redox;
   a is 1 or 2; and
   b is 1 or 2.

The invention also provides the use of a compound of formula (A) for measuring the acidity and redox potential of a sample:

Acc(-L¹-)ₐFluo(-L²-)_{b}Redox (A);
wherein:
   Acc is a proton acceptor moiety;
   Fluo is a fluorophore;
   Redox is a redox unit;
   each L¹ is a first spacer group which is bonded to Acc and Fluo;
   each L² is a second spacer group which is bonded to Fluo and Redox;
   a is 1 or 2; and
   b is 1 or 2.

### BRIEF DESCRIPTION OF THE FIGURES

FIG. 1—¹H NMR spectrum of compound 5 in CDCl₃.

FIG. 2—¹³C NMR spectrum of compound 5 in CDCl₃.

FIG. 3—Infra-red spectrum of compound 5 as a KBr disk.

FIG. 4—UV-Vis absorption spectra of 1×10⁻⁵ M of compound 5 in MeOH in the absence and presence of 25 mM methanesulfonic acid.

FIG. 5—UV-Vis absorption spectra of 1×10⁻⁵ M of compound 5 in 1:1 (v/v) MeOH:H₂O in the absence and presence of 25 mM methanesulfonic acid.

FIG. 6—UV-Vis absorption spectra of 1×10⁻⁵ M of compound 5 in 1:1 (v/v) MeOH:H₂O with increasing concentration of methanesulfonic acid between pH 2-10.

FIG. 7—Visual output of AND logic for compound 5 in 1:1 (v/v) MeOH:H₂O irradiated with a UV lamp with 365 nm light.

FIG. 8—Fluorescence spectra of compound 5 in 1:1 (v/v) MeOH:H₂O illustrating the AND logic functionality. The molar concentration of compound 5 at 3×10⁻⁶ M. The concentration of H⁺ and Fe(III) are 0.2 mM and 10 μM respectively.

FIG. 9—Fluorescence spectra of compound 5 as a function of [Fe(III)] in 1:1 (v/v) MeOH:H₂O.

FIG. 10—Fluorescence spectra of compound 5 as a function of [H⁺] in 1:1 (v/v) MeOH:H₂O.

FIG. 11—Fluorescence spectra of compound 5 in 1:1 (v/v) MeOH:H₂O in the presence of above threshold inputs of acid and oxidant and the fluorescence spectrum of anthracene in ethanol.

FIG. 12—Fluorescence spectra of compound 5 in 1:1 (v/v) MeOH:H₂O using H⁺ as titrant and Fe(III) in excess.

FIG. 13—Titration curve plotted at the maximum intensity of 525 nm against the pH (in presence of excess Fe(III)) in 1:1 (v/v) MeOH:H₂O.

FIG. 14—Henderson-Hasselbalch plot; Graph of log [(Iₘₐₓ−I)/(I−Iₘᵢₙ)] at 525 nm against the pH (with excess Fe(III)) in 1:1 (v/v) MeOH:H₂O

FIG. 15—Fluorescence spectra of compound 5 in 1:1 (v/v) MeOH:H₂O using Fe(III) as titrant and H⁺ in excess.

FIG. 16—Titration curve plotted at the maximum intensity at 525 nm against the −log [Fe³⁺] (in presence of excess H⁺) in 1:1 (v/v) MeOH:H₂O.

FIG. 17—Henderson-Hasselbalch plot; Graph of log [(Iₘₐₓ−I)/(I−Iₘᵢₙ)] at 525 nm against the −log [Fe³⁺] (with excess H⁺) in 1:1 (v/v) MeOH:H₂O.

### DETAILED DESCRIPTION OF THE INVENTION

Definitions

The term “alkyl”, as used herein, refers to a linear or branched saturated hydrocarbon chain. An alkyl group may be a C₁₋₁₈ alkyl group, a C₁₋₁₄ alkyl group, a C₁₋₁₀ alkyl group, a C₁₋₆ alkyl group or a C₁₋₄ alkyl group. Examples of a C₁₋₁₀ alkyl group are methyl, ethyl, propyl, butyl, pentyl, hexyl, heptyl, octyl, nonyl or decyl. Examples of C₁₋₆ alkyl groups are methyl, ethyl, propyl, butyl, pentyl or hexyl. Examples of C₁₋₄ alkyl groups are methyl, ethyl, i-propyl, n-propyl, t-butyl, s-butyl or n-butyl. If the term “alkyl” is used without a prefix specifying the number of carbons anywhere herein, it has from 1 to 6 carbon atoms (and this also applies to any other organic group referred to herein). The term “monohydroxyalkyl”, as used herein, refers to an alkyl group substituted with a single OH group. Examples of a monohydroxyalkyl group include those of formula —(CH₂)ₛOH wherein s is an integer from 1 to 8.

The term “cycloalkyl”, as used herein, refers to a saturated or partially unsaturated cyclic hydrocarbon chain. A cycloalkyl group may be a C₃₋₁₀ cycloalkyl group, a C₃₋₈ cycloalkyl group or a C₃₋₆ cycloalkyl group. Examples of a C₃₋₈ cycloalkyl group include cyclopropyl, cyclobutyl, cyclopentyl, cyclohexyl, cyclohexenyl, cyclohex-1,3-dienyl, cycloheptyl and cyclooctyl. Examples of a C₃₋₆ cycloalkyl group include cyclopropyl, cyclobutyl, cyclopentyl, and cyclohexyl.

The term “alkenyl”, as used herein, refers to a linear or branched hydrocarbon chain comprising one or more double bonds. An alkenyl group may be a C₂₋₁₈ alkenyl group, a C₂₋₁₄ alkenyl group, a C₂₋₁₀ alkenyl group, a C₂₋₆ alkenyl group or a C₂₋₄ alkenyl group. Examples of a C₂₋₁₀ alkenyl group are ethenyl(vinyl), propenyl, butenyl, pentenyl, hexenyl, heptenyl, octenyl, nonenyl or decenyl. Examples of C₂₋₆ alkenyl groups are ethenyl, propenyl, butenyl, pentenyl or hexenyl. Examples of C₂₋₄ alkenyl groups are ethenyl, i-propenyl, n-propenyl, s-butenyl or n-butenyl. Alkenyl groups typically comprise one or two double bonds.

The term “alkynyl”, as used herein, refers to a linear or branched hydrocarbon chain comprising one or more triple bonds. An alkynyl group may be a C₂₋₁₈ alkynyl group, a C₂₋₁₄ alkynyl group, a C₂₋₁₀ alkynyl group, a C₂₋₆ alkynyl group or a C₂₋₄ alkynyl group. Examples of a C₂₋₁₀ alkynyl group are ethynyl, propynyl, butynyl, pentynyl, hexynyl, heptynyl, octynyl, nonynyl or decynyl. Examples of C₁₋₆ alkynyl groups are ethynyl, propynyl, butynyl, pentynyl or hexnylyl. Alkynyl groups typically comprise one or two triple bonds.

The term “aryl”, as used herein, refers to a monocyclic, bicyclic or polycyclic aromatic ring which contains from 6 to 14 carbon atoms, typically from 6 to 10 carbon atoms, in the ring portion. Examples include phenyl, naphthyl, indenyl and indanyl groups. The term “aryl group”, as used herein, includes heteroaryl groups. The term “heteroaryl”, as used herein, refers to monocyclic or bicyclic heteroaromatic rings which typically contains from six to ten atoms in the ring portion including one or more heteroatoms. A heteroaryl group is generally a 5- or 6-membered ring, containing at least one heteroatom selected from O, S, N, P, Se and Si. It may contain, for example, one, two or three heteroatoms. Examples of heteroaryl groups include pyridyl, pyrazinyl, pyrimidinyl, pyridazinyl, furanyl, thienyl, pyrazolidinyl, pyrrolyl, oxazolyl, oxadiazolyl, isoxazolyl, thiadiazolyl, thiazolyl, isothiazolyl, imidazolyl, pyrazolyl, quinolyl and isoquinolyl.

The terms “alkylene”, “cycloalkylene”, “alkenylene”, “alkynylene”, and “arylene”, as used herein, refer to bivalent groups obtained by removing a hydrogen atom from an alkyl, cycloalkyl, alkenyl, alkynyl, or aryl group, respectively. An alkylene group may be a C₁₋₁₈ alkylene group, a C₁₋₁₄ alkylene group, a C₁₋₁₀ alkylene group, a C₁₋₆ alkylene group or a C₁₋₄ alkylene group. Examples of C₁₋₆ alkylene groups are methylene, ethylene, propylene, butylene, pentylene and hexylene. A cycloalkylene group may be a C₃₋₁₀ cycloalkylene group, a C₃₋₈ cycloalkylene group or a C₃₋₆ cycloalkylene group. Examples of C₃₋₈ cycloalkylene groups include cyclopentylene(cyclopentanediyl), cyclohexylene(cyclohexanediyl) and bicyclo[2.2.2]octanediyl. An alkenylene group may be a C₂₋₁₈ alkenylene group, a C₂₋₁₄ alkenylene group, a C₂₋₁₀ alkenylene group, a C₂₋₆ alkenylene group or a C₂₋₄ alkenylene group. Examples of a C₂₋₄ alkenylene group include ethenylene(vinylene), propenylene and butenylene. An alkynylene group may be a C₂₋₁₈ alkynylene group, a C₂₋₁₄ alkynylene group, a C₂₋₁₀ alkynylene group, a C₂₋₆ alkynylene group or a C₂₋₄ alkynylene group. Examples of a C₂₋₄ alkynylene group include ethynylene and propynylene. Examples of arylene groups include phenylene and a diradical derived from thiophene. For alkylene, cycloalkylene, alkenylene, alkynylene, and arylene, these groups may be bonded to other groups at any two positions on the group. Thus, propylene includes —CH₂CH₂CH₂— and —CH₂CH(CH₃)—, and phenylene includes ortho-, meta- and para-phenylene.

The term “substituted”, as used herein in the context of substituted organic groups, refers to an organic group which bears one or more substituents selected from C₁₋₁₀ alkyl, aryl, heteroaryl, cyano, amino, nitro, C₁₋₁₀ alkylamino, di(C₁₋₁₀)alkylamino, arylamino, diarylamino, aryl(C₁₋₁₀)alkylamino, amido, acylamido, hydroxy, formyl, oxo, halo, carboxy, ester, acyl, acyloxy, C₁₋₁₀ alkoxy, aryloxy, halo(C₁₋₁₀)alkyl, sulfonic acid, thiol, C₁₋₁₀ alkylthio, arylthio, sulfonyl, phosphoric acid, phosphate ester, phosphonic acid and phosphonate ester. Examples of substituted alkyl groups include haloalkyl, perhaloalkyl, hydroxyalkyl, aminoalkyl, alkoxyalkyl and alkaryl groups. The one or more substituents are themselves unsubstituted. When a group is substituted, it may bear 1, 2 or 3 substituents. For instance, a substituted group may have 1 or 2 substitutents.

As used herein the term “oxo” represents a group of formula: ═O

As used herein the term “acyl” represents a group of formula: —C(═O)R, wherein R is an acyl substituent, for example, a substituted or unsubstituted C₁₋₂₀ alkyl group, substituted or unsubstituted C₂₋₂₀ alkenyl group, substituted or unsubstituted C₂₋₂₀ alkynyl group, a substituted or unsubstituted C₃₋₂₀ heterocyclyl group, a substituted or unsubstituted aryl group or a substituted or unsubstituted heteroaryl group, for instance a substituted or unsubstituted C₁₋₆ alkyl group. Examples of acyl groups include, but are not limited to, —C(═O)CH₃(acetyl), —C(═O)CH₂CH₃(propionyl), —C(═O)C(CH₃)₃(t-butyryl), and —C(═O)Ph(benzoyl, phenone).

As used herein the term “acyloxy” (or reverse ester) represents a group of formula: —OC(═O)R, wherein R is an acyloxy substituent, for example, a substituted or unsubstituted C₁₋₂₀ alkyl group, substituted or unsubstituted C₂₋₂₀ alkenyl group, substituted or unsubstituted C₂₋₂₀ alkynyl group, a substituted or unsubstituted C₃₋₂₀ heterocyclyl group, a substituted or unsubstituted aryl group or a substituted or unsubstituted heteroaryl group, for instance a substituted or unsubstituted C₁₋₆ alkyl group. Examples of acyloxy groups include, but are not limited to, —OC(═O)CH₃(acetoxy), —OC(═O)CH₂CH₃, —OC(═O)C(CH₃)₃, —OC(═O)Ph, and —OC(═O)CH₂Ph.

As used herein the term “ester” (or carboxylate, carboxylic acid ester or oxycarbonyl) represents a group of formula: —C(═O)OR, wherein R is an ester substituent, for example, a substituted or unsubstituted C₁₋₂₀ alkyl group, substituted or unsubstituted C₂₋₂₀ alkenyl group, substituted or unsubstituted C₂₋₂₀ alkynyl group, a substituted or unsubstituted C₃₋₂₀ heterocyclyl group, a substituted or unsubstituted aryl group or a substituted or unsubstituted heteroaryl group, for instance a substituted or unsubstituted C₁₋₆ alkyl group. Examples of ester groups include, but are not limited to, —C(═O)OCH₃, —C(═O)OCH₂CH₃, —C(═O)OC(CH₃)₃, and —C(═O)OPh.

As used herein the term “amino” represents a group of formula —NH₂. The term “C₁-C₁₀ alkylamino” represents a group of formula —NHR′ wherein R′ is a C₁₋₁₀ alkyl group, preferably a C₁₋₆ alkyl group, as defined previously. The term “di(C₁₋₁₀)alkylamino” represents a group of formula —NR′R″ wherein R′ and R″ are the same or different and represent C₁₋₁₀ alkyl groups, preferably C₁₋₆ alkyl groups, as defined previously. The term “arylamino” represents a group of formula —NHR′ wherein R′ is an aryl group, preferably a phenyl group, as defined previously. The term “diarylamino” represents a group of formula —NR′R″ wherein R′ and R″ are the same or different and represent aryl groups, preferably phenyl groups, as defined previously. The term “arylalkylamino” represents a group of formula —NR′R″ wherein R′ is a C₁₋₁₀ alkyl group, preferably a C₁₋₆ alkyl group, and R″ is an aryl group, preferably a phenyl group.

A halo group is chlorine, fluorine, bromine or iodine (a chloro group, a fluoro group, a bromo group or an iodo group). It is typically chlorine, fluorine or bromine

As used herein the term “amido” represents a group of formula: —C(═O)NR′R″, wherein R′ and R″ are independently amino substituents, as defined for di(C₁₋₁₀)alkylamino groups. Examples of amido groups include, but are not limited to, —C(═O)NH₂, —C(═O)NHCH₃, —C(═O)N(CH₃)₂, —C(═O)NHCH₂CH₃, and —C(═O)N(CH₂CH₃)₂, as well as amido groups in which R′ and R″, together with the nitrogen atom to which they are attached, form a heterocyclic structure as in, for example, piperidinocarbonyl, morpholinocarbonyl, thiomorpholinocarbonyl, and piperazinocarbonyl.

As used herein the term “acylamido” represents a group of formula: —NR¹C(═O)R², wherein R¹ is an amide substituent, for example, hydrogen, a C₁₋₂₀alkyl group, a C₃₋₂₀ heterocyclyl group, an aryl group, preferably hydrogen or a C₁₋₂₀ alkyl group, and R² is an acyl substituent, for example, a C₁₋₂₀ alkyl group, a C₃₋₂₀ heterocyclyl group, or an aryl group, preferably hydrogen or a C₁₋₂₀ alkyl group. Examples of acylamide groups include, but are not limited to, —NHC(═O)CH₃, —NHC(═O)CH₂CH₃, —NHC(═O)Ph, —NHC(═O)C₁₅H₃₁ and —NHC(═O)C₉H₁₉. Thus, a substituted C₁₋₂₀ alkyl group may comprise an acylamido substituent defined by the formula —NHC(═O)—C₁₋₂₀alkyl, such as —NHC(═O)C₁₅H₃₁ or —NHC(═O)C₉H₁₉. R¹ and R² may together form a cyclic structure, as in, for example, succinimidyl, maleimidyl, and phthalimidyl.

A C₁₋₁₀ alkylthio group is a said C₁₋₁₀ alkyl group, preferably a C₁₋₆ alkyl group, attached to a thio group. An arylthio group is an aryl group, preferably a phenyl group, attached to a thio group.

A C₁₋₂₀ alkoxy group is a said substituted or unsubstituted C₁₋₂₀ alkyl group attached to an oxygen atom. A C₁₋₆ alkoxy group is a said substituted or unsubstituted C₁₋₆ alkyl group attached to an oxygen atom. A C₁₋₄ alkoxy group is a substituted or unsubstituted C₁₋₄ alkyl group attached to an oxygen atom. Said C₁₋₂₀, C₁₋₆ and C₁₋₄ alkyl groups are optionally interrupted as defined herein. Examples of C₁₋₄ alkoxy groups include, —OMe (methoxy), —OEt (ethoxy), —O(nPr) (n-propoxy), —O(iPr) (isopropoxy), —O(nBu) (n-butoxy), —O(sBu) (sec-butoxy), —O(iBu) (isobutoxy), and —O(tBu) (tert-butoxy). Further examples of C₁₋₂₀ alkoxy groups are —O(Adamantyl), —O—CH₂-Adamantyl and —O—CH₂—CH₂-Adamantyl. An aryloxy group is a substituted or unsubstituted aryl group, as defined herein, attached to an oxygen atom. An example of an aryloxy group is —OPh (phenoxy).

Method of Measuring Acidity and Oxidation Potential of a Sample

The invention provides a method of measuring the acidity and redox potential of a sample, which method comprises:
(i) contacting a compound of formula (A) with the sample:

Acc(-L¹-)ₐFluo(-L²-)_{b}Redox (A);
wherein:
   Acc is a proton acceptor moiety;
   Fluo is a fluorophore;
   Redox is a redox unit;
   each L¹ is a first spacer group which is bonded to Acc and Fluo;
   each L² is a second spacer group which is bonded to Fluo and Redox;
   a is 1 or 2; and
   b is 1 or 2; and
(ii) exposing the sample to a light source, measuring fluorescence and thereby determining the acidity and redox potential of the sample.

If two L¹ spacer groups (or L² spacer groups) are present in the compound of formula (A), these two L¹ spacer groups (or L² spacer groups) are in parallel. Thus, formula (A) includes: compounds of formula (A1) when a and b are both 2; compounds of formula (A2) when a is 2 and b is 1; compounds of formula (A3) when a is 1 and b is 2; and compounds of formula (A4) when a and b are 1. Typically, the compound of formula (A) is a compound of formula (A2) or formula (A4).

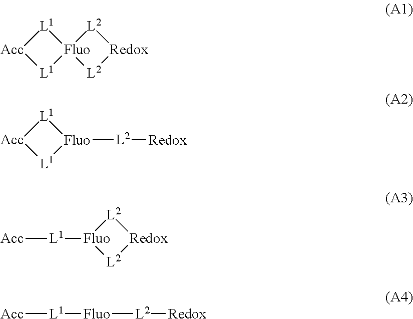

If two L¹ spacer groups (or L² spacer groups) are present in the compound of formula (A), the two L¹ spacer groups (or L² spacer groups) may be bonded to the same or different atoms in Acc and the same or different atoms in Fluo (the same or different atoms in Redox and the same or different atoms in Fluo). Often, they are bonded to the same atom in Acc and the same atom in Fluo (or the same atom in Redox and the same atom in Fluo).

Proton Acceptor Moiety

The proton acceptor moiety, Acc, may be any suitable proton acceptor moiety. Generally, the acid conjugate of Acc, Acc-H⁺, has a pKₐ of greater than or equal to 0 (for example, pyridine-H⁺ has a pKₐ of 5.20, while triethylamine-H⁺ has a pKₐ of 9.8 and diethylamine-H+ has a pKₐ of 11.00). If the pKₐ of Acc-H⁺ is more than 0, this excludes groups such as —OH (e.g. pKₐ of CH₃OH₂⁺ is −2.5). Thus, generally, Acc does not comprise only an OH group (although it may comprise an OH group in addition to a more basic group). Acc-H⁺ refers to the acid conjugate of the most basic part of Acc, and therefore Acc may comprise non-basic moieties in addition to the basic moiety which acts as the proton acceptor. Often, however, Acc does not comprise any OH group.

The basicity (i.e. the pKₐ of the conjugate acid or pKb of Acc) of Acc can be varied in order to change the acidity above which the compound of formula (A) will show an input for acidity. For instance, the acid conjugate of Acc, Acc-H⁺, may have a pKₐ of greater than or equal to 2.0, or greater than or equal to 3.0. In some cases, the acid conjugate of Acc, Acc-H⁺, may have a pKₐ of greater than or equal to 5.0, or greater than or equal to 7.0. Such values are typically values as measured at 25° C. pKₐ values for conjugate acids are readily available from standard data tables. For instance, the conjugate acid of methylamine, MeNH₃⁺, has a pKₐ value of 10.66 at 25° C., the conjugate acid of trimethylamine, Me₃NH⁺, has a pKₐ value of 9.80 at 25° C., and the conjugate acid of pyridine, pyr-H⁺, has a pKₐ value of 5.23 at 25° C.

Typically, the proton acceptor moiety (Acc) comprises one or more heteroatoms, for instance N, O, S and/or P atoms. More typically, Acc comprises one or more N atoms. For instance, Acc often comprises at least one N atom with a basic lone pair. Lone pairs on N atoms are less basic if they are conjugated with π-systems. Thus, in one embodiment, Acc comprises an N atom the lone pair of which is not conjugated with a π-system. For instance, Acc typically comprises an N atom which is not directly bonded to a benzene ring.

Acc typically comprises a group selected from a primary amine group (—NH₂), a secondary amine group (>NH), a tertiary amine group (>N—), a pyridine group, an imidazole group, a pyrrolidine group, a morpholine group, a piperazine group, a piperidine group, an azepane group, a thiomorpholine group, a 2H-pyrrole group, a 2-pyrroline group, a 3-pyrroline group, a 2-imidazoline group, an imidazolidine group, a 2-pyrazoline group, a pyrazolidine group, a 3H-indole group, an indoline group and a quinuclidine group. Each of these groups may be substituted or unsubstituted.

Acc is more typically a group selected from:

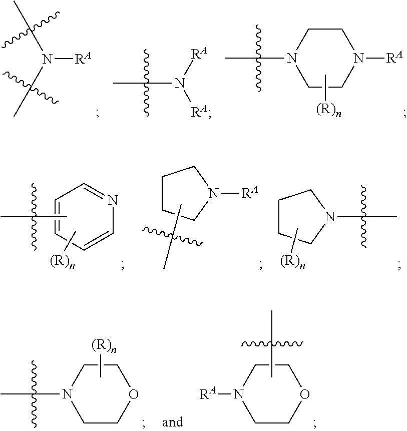

wherein:
each R is independently a substituent selected from substituted or unsubstituted C₁₋₁₀ alkyl, substituted or unsubstituted C₂₋₁₀ alkenyl, substituted or unsubstituted C₂₋₁₀ alkynyl, substituted or unsubstituted aryl, substituted or unsubstituted heteroaryl, cyano, amino, nitro, substituted or unsubstituted C₁₋₁₀ alkylamino, substituted or unsubstituted di(C₁₋₁₀)alkylamino, substituted or unsubstituted arylamino, substituted or unsubstituted diarylamino, substituted or unsubstituted aryl(C₁₋₁₀)alkylamino, amido, acylamido, hydroxy, oxo, halo, carboxy, ester, acyl, acyloxy, substituted or unsubstituted C₁₋₁₀ alkoxy, substituted or unsubstituted aryloxy, halo(C₁₋₁₀)alkyl, sulfonic acid, thiol, substituted or unsubstituted C₁₋₁₀ alkylthio, arylthio, sulfonyl, phosphoric acid, phosphate ester, phosphonic acid and phosphonate ester;
each R^{A} is independently a substituent selected from H, substituted or unsubstituted C₁₋₈ alkyl and substituted or unsubstituted aryl, and where two R^{A} groups may be bonded together to form a substituted or unsubstituted C₁₋₈ alkylene group;
n is an integer from 0 to 4; and
each [symbol] represents a bond to an L¹.

n is typically 0, 1 or 2.

Typically, each R is independently a substituent selected from unsubstituted C₁₋₁₀ alkyl, C₁₋₁₀ alkyl substituted with 1, 2 or 3 OH groups, unsubstituted C₂₋₁₀ alkenyl, unsubstituted C₂₋₁₀ alkynyl, unsubstituted aryl, unsubstituted heteroaryl, cyano, amino, nitro, unsubstituted C₁₋₁₀ alkylamino, unsubstituted di(C₁₋₁₀)alkylamino, unsubstituted arylamino, —C(O)O—R^{C}, —OC(O)—R^{C}, —C(O)—R^{C}, —N(R^{C})C(O)—R^{C}, —C(O)N(R^{C})—R^{C}, hydroxy, oxo, halo, C₁₋₁₀ alkyl substituted with 1, 2 or 3 halo groups, wherein each R^{C} is H or unsubstituted C₁₋₄ alkyl.

For instance, each R may be independently a substituent selected from OH, NH₂, halo, unsubstituted C₁₋₈ alkyl, unsubstituted C₁₋₈ alkoxy, unsubstituted C₁₋₈ alkylamino, unsubstituted C₁₋₈ dialkylamino, unsubstituted C₁₋₈ monohydroxyalkyl and phenyl.

Examples of R groups in Acc include methyl (Me), ethyl (Et), propyl (Pr), butyl (Bu), NH₂, NMe₂, NEt₂, NPr₂, OH, OMe, OEt, OPr, OBu, CH₂OH, CH₂CH₂OH, CH₂CH₂CH₂OH, and CH₂CH₂CH₂CH₂OH.

For instance, Acc may be a group selected from:

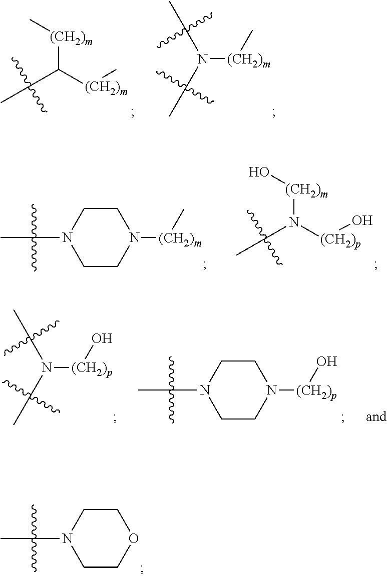

wherein:
m is an integer from 0 to 8;
p is an integer from 1 to 8; and
each [symbol] represents a bond to an L¹.

Acc is often a group selected from:

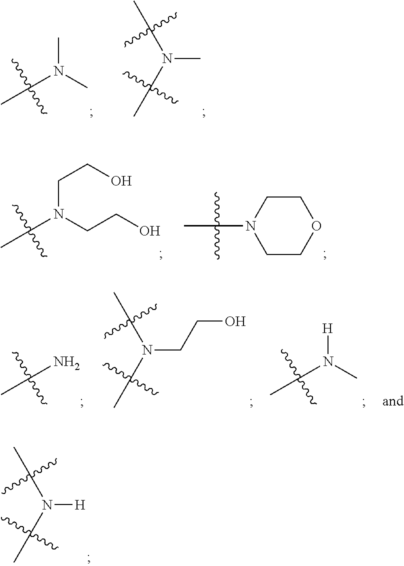

wherein each [symbol] represents a bond to an L¹.

If the moiety for Acc comprises two [symbol] bonds, then each of these two bonds is connected to an L¹ and the compound comprises two L¹ spacer groups. For instance, a compound of formula (A) which comprises an Acc group of formula

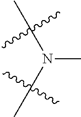 [SMILES: *N(*)C]

will have the formula:

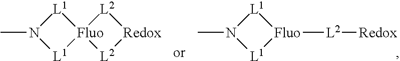

for instance, the formula:

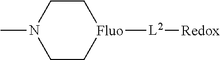

(where here there are two L¹ groups, each of which is ethylene).

Fluorophore

A fluorophore absorbs radiating energy, induces internal electron transfers and finally emits the excited energy returning it back to its ground state. Fluorescence is the emission of photons after deexcitation from the excited singlet state to the ground singlet state (S₁→S₀). Every fluorophore has a particular energy gap between the HOMO and the LUMO. Hence, each fluorophore requires a characteristic amount of energy to promote an electron from S₀ to S₁. Fluorophores can be divided into three classes: quantum dots, biological and organic dyes. The fluorophore is typically an organic dye, or a semiconductor quantum dot, or a fluorescent protein or a lanthanide complex.

Fluo may be a fluorophore, as defined above, which comprises at least one aromatic ring. At least one aromatic ring is generally selected from aryl and heteroaryl groups.

Usually, however, Fluo is a fluorophore comprising two or more fused aromatic rings, a fluorophore comprising a heteroaryl group comprising two or more heteroatoms, or a fluorophore comprising a metal ion containing complex comprising ligands which comprise two or more aromatic rings. Whether a group is a fluorophore or not may be easily verified by the skilled person, for instance, by performing fluorescence spectroscopy or irradiating a sample with UV-visible light.

Often, Fluo is a fluorophore comprising one or more carbonyl (>C═O) groups, for instance two or more carbonyl groups. Examples of such fluorophores include those comprising a 1,8-naphthalimide group, an 4-amino-1,8-naphthalimide group, a perylene-3,4,9,10-tetracarboxylic acid diimide group (perylenediimide), coumarin group, rhodamine group, fluorescein group, eosin group, erythrosine group, among others. Such fluorophores may display favourable water solubility.

Typically, the fluorophore (in the compound (A)) has a maximum fluorescence wavelength (λₘₐₓ) from 300 nm to 800 nm. For instance, λₘₐₓ may be from 450 nm to 600 nm, or from 500 nm to 550 nm.

In some cases, the fluorophore is not symmetrical. For instance, the fluorophore may comprise no more than two planes of symmetry, or no more than one plane of symmetry.

Typically, Fluo is a fluorophore selected from moieties of the following formulae:

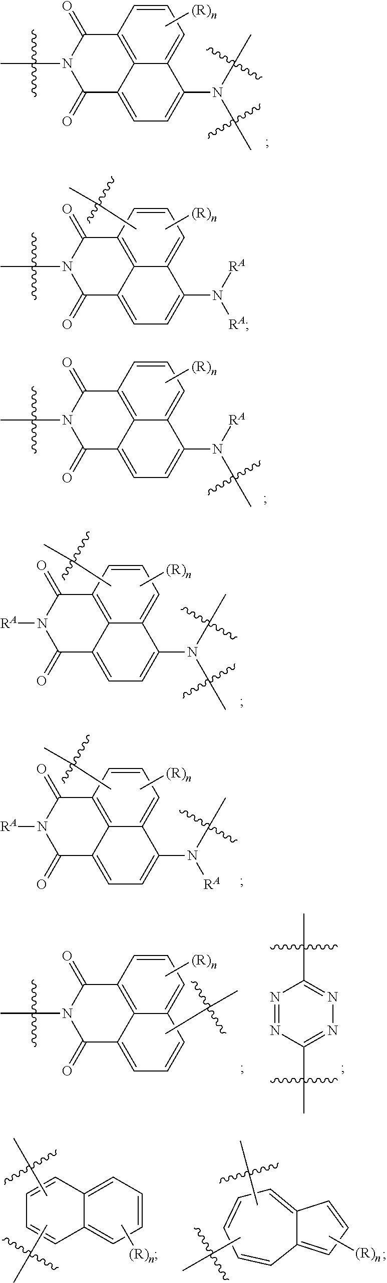

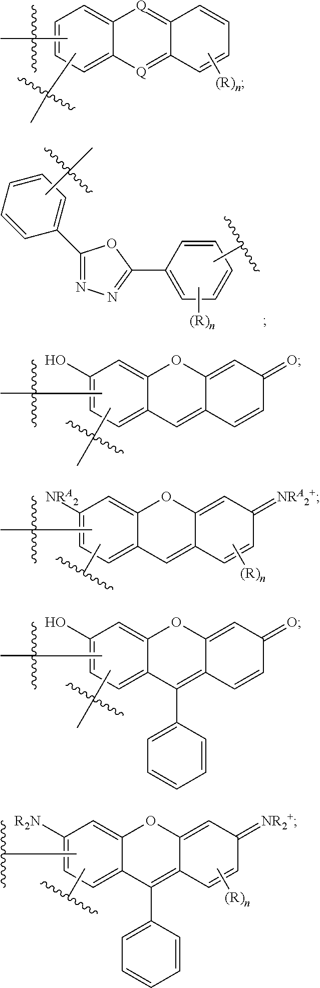

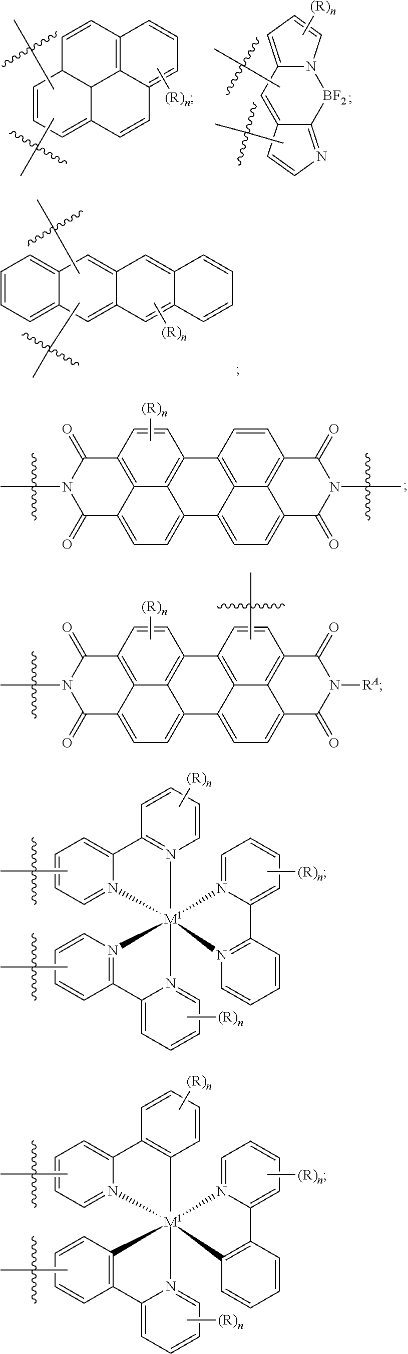

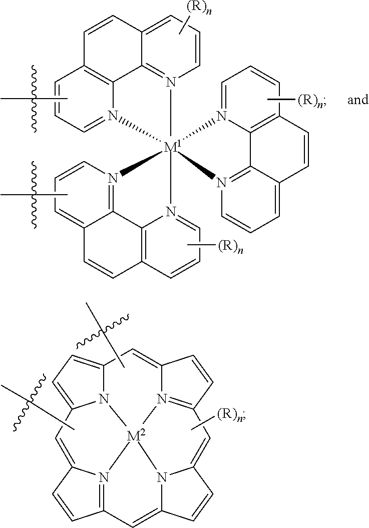

wherein:
each Q is independently N, NR⁺ or CH;
each R is independently a substituent selected from substituted or unsubstituted C₁₋₁₀ alkyl, substituted or unsubstituted C₂₋₁₀ alkenyl, substituted or unsubstituted C₂₋₁₀ alkynyl, substituted or unsubstituted aryl, substituted or unsubstituted heteroaryl, cyano, amino, nitro, substituted or unsubstituted C₁₋₁₀ alkylamino, substituted or unsubstituted di(C₁₋₁₀)alkylamino, substituted or unsubstituted arylamino, substituted or unsubstituted diarylamino, substituted or unsubstituted aryl(C₁₋₁₀)alkylamino, amido, acylamido, hydroxy, oxo, halo, carboxy, ester, acyl, acyloxy, substituted or unsubstituted C₁₋₁₀ alkoxy, substituted or unsubstituted aryloxy, halo(C₁₋₁₀)alkyl, sulfonic acid, thiol, substituted or unsubstituted C₁₋₁₀ alkylthio, arylthio, sulfonyl, phosphoric acid, phosphate ester, phosphonic acid and phosphonate ester;
each R^{A} is independently a substituent selected from H, substituted or unsubstituted C₁₋₈ alkyl and substituted or unsubstituted aryl, and where two R^{A} groups may be bonded together to form a substituted or unsubstituted C₁₋₈ alkylene group;
M¹ is a metal atom;
M² is a metal atom;
n is an integer from 0 to 8; and
each [symbol] represents a bond to either an L¹ or an L².

Fluorophores often contain several fused aromatic rings. The first and second linkers may be attached to any of the rings as appropriate. It should be noted that the formula

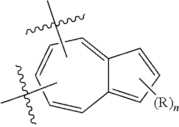

includes

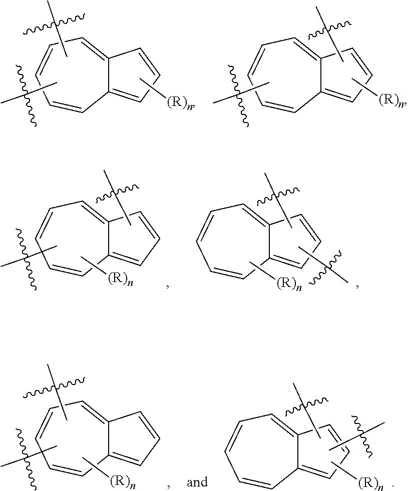

Furthermore, if Fluo is substituted with one or more R groups, these may be attached to the same or different rings. Thus,

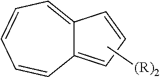

includes

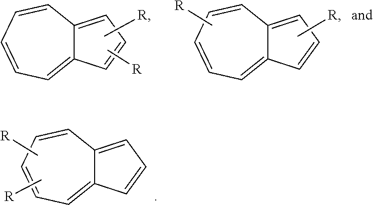

M¹ may be any suitable metal atom. Typically, M¹ is in the oxidation state I, II or III. M¹ is typically selected from Ru, Rh, Pt and Ir.

M² may be any suitable metal atom. Typically, M² is in the oxidation state I, II or III. M² is typically selected from Zn, Mg and Ni.

Fluo may be a lanthanide complex such as

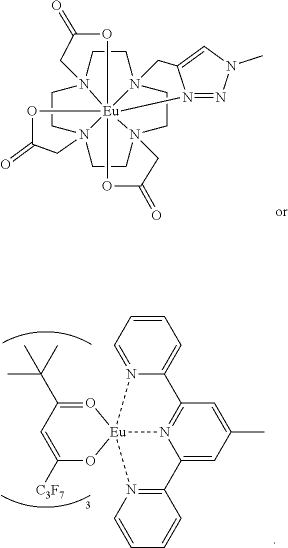

n is typically 0, 1, 2 or 3. Often, n is 0 or 1.

Typically, each R is independently a substituent selected from unsubstituted C₁₋₁₀ alkyl, C₁₋₁₀ alkyl substituted with 1, 2 or 3 OH groups, unsubstituted C₂₋₁₀ alkenyl, unsubstituted C₂₋₁₀ alkynyl, unsubstituted aryl, unsubstituted heteroaryl, cyano, amino, nitro, unsubstituted C₁₋₁₀ alkylamino, unsubstituted di(C₁₋₁₀)alkylamino, unsubstituted arylamino, —C(O)O—R^{C}, —OC(O)—R^{C}, —C(O)—R^{C}, —N(R^{C})C(O)—R^{C}, —C(O)N(R^{C})—R^{C}, hydroxy, oxo, halo, C₁₋₁₀ alkyl substituted with 1, 2 or 3 halo groups, wherein each R^{C} is H or unsubstituted C₁₋₄ alkyl.

For instance, each R may be independently a substituent selected from OH, NH₂, halo, unsubstituted C₁₋₈ alkyl, unsubstituted C₁₋₈ alkoxy, unsubstituted C₁₋₈ alkylamino, unsubstituted C₁₋₈ dialkylamino, unsubstituted C₁₋₈ monohydroxyalkyl and phenyl.

If two [symbol] bonds are bonded to the same atom, then typically: both [symbol] bonds are bonded to an L¹; or both [symbol] bonds are bonded to an L².

Fluo is more typically a fluorophore selected from moieties of the following formulae:

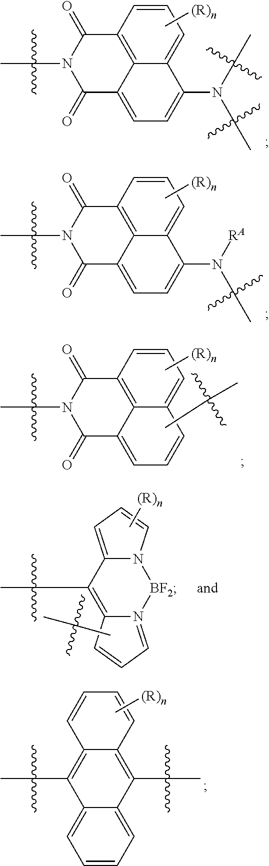

wherein:
each R is independently a substituent selected from OH, NH₂, halo, unsubstituted C₁₋₈ alkyl, unsubstituted C₁₋₈ alkoxy, unsubstituted C₁₋₈ alkylamino, unsubstituted C₁₋₈ dialkylamino, unsubstituted C₁₋₈ monohydroxyalkyl and phenyl;
R^{A} is a substituent selected from H, unsubstituted C₁₋₈ alkyl, unsubstituted C₁₋₈ monohydroxyalkyl and phenyl;
n is an integer from 0 to 6; and
each [symbol] represents a bond to either an L¹ or an L².

Examples of R groups in Fluo include methyl (Me), ethyl (Et), propyl (Pr), butyl (Bu), NH₂, NMe₂, NEt₂, NPr₂, OH, OMe, OEt, OPr, OBu, CH₂OH, CH₂CH₂OH, CH₂CH₂CH₂OH, and CH₂CH₂CH₂CH₂OH. For instance, —(R)ₙ may represent 1, 2 or 3 groups selected from methyl (Me), ethyl (Et), propyl (Pr), butyl (Bu), NH₂, NMe₂, NEt₂, NPr₂, OH, OMe, OEt, OPr, OBu, CH₂OH, CH₂CH₂OH, CH₂CH₂CH₂OH, and CH₂CH₂CH₂CH₂OH.

Preferably, Fluo comprises an 1,8-naphthalimide group or an 4-amino-1,8-naphthalimide group, more preferable an 4-amino-1,8-naphthalimide group.

Thus, Fluo is often:

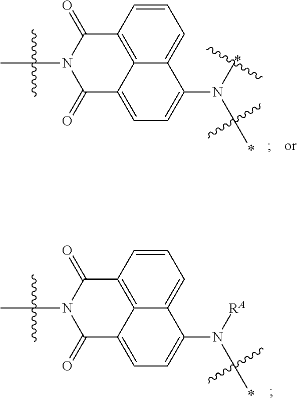

wherein:
R^{A} is a substituent selected from H, unsubstituted C₁₋₈ alkyl, unsubstituted C₁₋₈ monohydroxyalkyl and phenyl; and either
(a) [symbol] represents a bond to L¹ and each [symbol] represents a bond to an L²; or
(b) [symbol] represents a bond to L² and each [symbol] represents a bond to an L¹.

Redox Unit

The design of efficient redox switches and logic gates can require careful selection of the redox control units. The redox unit is preferably interconverted quickly and reversibly. For fluorescence sensing purposes the ideal redox unit has a selective reversible or irreversible chemical redox reaction. Commonly used redox units are quinones or catechols, ferrocene, tetrathiafulvene, nitroxide or ligands stabilized with transition metals such as ruthenium, osmium, nickel or copper. The emission can be quenched by either photoinduced electron transfer, energy transfer or charge transfer.

Typically, Redox comprises a group selected from a quinone group, a catechol group, a metallocene group, a tetrathiafulvene group, a triarylamine group and a nitroxide group.

A quinone group has the formulae:

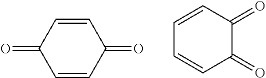

A catechol group has the formulae:

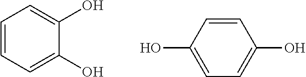 [SMILES: Oc1ccccc1O ; Oc1ccc(O)cc1]

A metallocene group is a group comprising two substituted or unsubstituted cyclopentadienyl groups and a metal atom. The metal atom is typically Fe, Co, Cr or Ni, and the metal atom is typically a cation (for instance Fe²⁺).

A tetrathiafulvene group has the formula

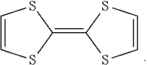

Other related derivatives of tetrathiafulvane with other heteroatoms such as N or P or Se are also examples of redox groups.

A triarylamine group has the formula NAr₃ wherein each Ar is a substituted or unsubstituted aryl group, for instance one or more of each Ar may be phenyl ring optionally substituted with one or more electron-donating or electron-withdrawing groups.

A nitroxide group is a group comprising the moiety >N—O*, where O* is a free radical.

Redox is typically a redox unit selected from moieties of the following formulae:

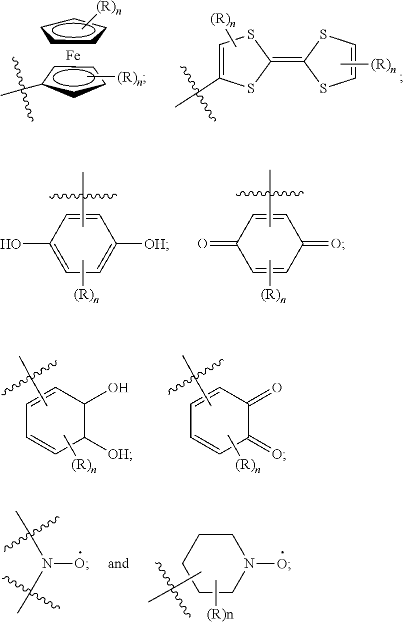

wherein:
each R is independently a substituent selected from substituted or unsubstituted C₁₋₁₀ alkyl, substituted or unsubstituted C₂₋₁₀ alkenyl, substituted or unsubstituted C₂₋₁₀ alkynyl, substituted or unsubstituted aryl, substituted or unsubstituted heteroaryl, cyano, amino, nitro, substituted or unsubstituted C₁₋₁₀ alkylamino, substituted or unsubstituted di(C₁₋₁₀)alkylamino, substituted or unsubstituted arylamino, substituted or unsubstituted diarylamino, substituted or unsubstituted aryl(C₁₋₁₀)alkylamino, amido, acylamido, hydroxy, oxo, halo, carboxy, ester, acyl, acyloxy, substituted or unsubstituted C₁₋₁₀ alkoxy, substituted or unsubstituted aryloxy, halo(C₁₋₁₀)alkyl, sulfonic acid, thiol, substituted or unsubstituted C₁₋₁₀ alkylthio, arylthio, sulfonyl, phosphoric acid, phosphate ester, phosphonic acid and phosphonate ester;
n is an integer from 0 to 4; and
each [symbol] represents a bond to an L².

Typically, each R is independently a substituent selected from unsubstituted C₁₋₁₀ alkyl, C₁₋₁₀ alkyl substituted with 1, 2 or 3 OH groups, unsubstituted C₂₋₁₀ alkenyl, unsubstituted C₂₋₁₀ alkynyl, unsubstituted aryl, unsubstituted heteroaryl, cyano, amino, nitro, unsubstituted C₂₋₁₀ alkylamino, unsubstituted di(C₁₋₁₀)alkylamino, unsubstituted arylamino, —C(O)O—R^{C}, —OC(O)—R^{C}, —C(O)—R^{C}, —N(R^{C})C(O)—R^{C}, —C(O)N(R^{C})—R^{C}, hydroxy, oxo, halo, C₁₋₁₀ alkyl substituted with 1, 2 or 3 halo groups, wherein each R^{C} is H or unsubstituted C₁₋₄ alkyl.

For instance, each R may be independently a substituent selected from OH, NH₂, halo, unsubstituted C₁₋₈ alkyl, unsubstituted C₁₋₈ alkoxy, unsubstituted C₁₋₈ alkylamino, unsubstituted C₁₋₈ dialkylamino, unsubstituted C₁₋₈ monohydroxyalkyl and phenyl.

Examples of R groups in Redox include methyl (Me), ethyl (Et), propyl (Pr), butyl (Bu), NH₂, NMe₂, NEt₂, NPr₂, OH, OMe, OEt, OPr, OBu, CH₂OH, CH₂CH₂OH, CH₂CH₂CH₂OH, and CH₂CH₂CH₂CH₂OH.

n is typically 0, 1 or 2.

More typically, Redox is a redox unit selected from moieties of the following formulae:

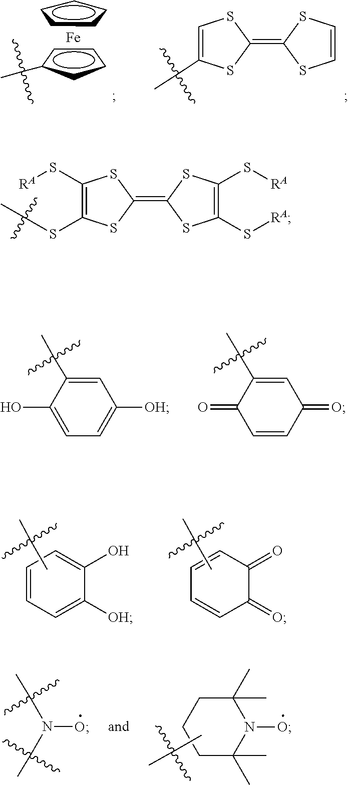

wherein:
R^{A} is a substituent selected from H, unsubstituted C₁₋₈ alkyl, unsubstituted C₁₋₈ monohydroxyalkyl and phenyl; and
each [symbol] represents a bond to an L².

Preferably, Redox comprises a metallocene group, for instance ferrocene. Thus, Redox often is:

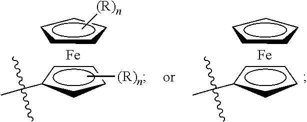

wherein each R may be independently a substituent selected from OH, NH₂, halo, unsubstituted C₁₋₈ alkyl, unsubstituted C₁₋₈ alkoxy, unsubstituted C₁₋₈ alkylamino, unsubstituted C₁₋₈ dialkylamino, unsubstituted C₁₋₈ monohydroxyalkyl and phenyl; n is an integer from 0 to 4; and [symbol] represents a bond to L².

Spacer Groups.

As discussed above, compound (A) may comprise one or two spacer groups between Acc and Fluo, or between Fluo and Redox.

Typically, each L¹ and each L² are independently selected from a direct bond, a substituted or unsubstituted C₁₋₈ alkylene group, a substituted or unsubstituted C₄₋₁₂ cycloalkylene group, a substituted or unsubstituted arylene group and groups of formula -alk-ary-, -alk-ary-alk-, —O-alk-, —O-alk-O—, -alk-O-alk-, -alk-O-alk-O—, -alk-O-alk-O-alk-, —O-ary-, -alk-O-ary, -alk-N(R^{A})—, -alk-N(R^{A})-alk-, -ary-N(R^{A})—, -alk-N(R^{A})-ary-, —C(O)—N(R^{A})-alk-, -alk-C(O)—N(R^{A})—, -alk-C(O)—N(R^{A})-alk-, —C(O)—O-alk-, -alk-C(O)—O, -alk-C(O)—O-alk-, —C(O)-alk-, -alk-C(O)-alk-, —C(R^{A})═C(R^{A})—, -alk-C(R^{A})═C(R^{A})—, -alk-C(R^{A})═C(R^{A})-alk, —C≡C—, -alk-C≡C—, and -alk-C≡C-alk-, wherein: alk is a substituted or unsubstituted C₁₋₄ alkylene group; ary is a substituted or unsubstituted arylene group; and each R^{A} is independently a substituent selected from H, substituted or unsubstituted C₁₋₈ alkyl and substituted or unsubstituted aryl. alk is typically an unsubstituted C₁₋₃ alkylene group, for instance methylene(methanediyl), ethylene or propylene.

L¹ and L² are spacer groups and thus are not typically direct bonds. Direct bonds between Acc and Fluo (or between Redox and Fluo) can lead to conjugation between Acc and Fluo (or between Redox and Fluo) which can detrimentally affect the fluorescence properties of Fluo, the basicity properties of Acc or the redox properties of Redox. If direct bonds are present as spacers, they are often referred to as “virtual spacers”. Virtual (i.e. direct bond) spacers may be present in compounds comprising two or more aryl systems that are orthogonal in their ground state. Upon excitation the aryl systems may become co-planar. In some cases, the spacer is not ethylene (—CH═CH—) or acetylene (—C≡C—).

For instance, each L¹ and each L² may be independently selected from a substituted or unsubstituted C₁₋₈ alkylene group, a substituted or unsubstituted C₄₋₁₂ cycloalkylene group, a substituted or unsubstituted arylene group and groups of formula -alk-ary-, -alk-ary-alk-, —O-alk-, —O-alk-O—, -alk-O-alk-, -alk-O-alk-O—, -alk-O-alk-O-alk—, —O-ary, -alk-O-ary-, -alk-N(R^{A})—, -alk-N(R^{A})-alk-, -ary-N(R^{A})—, -alk-N(R^{A})-ary-, —C(O)—N(R^{A})-alk-, -alk-C(O)—N(R^{A})—, -alk-C(O)—N(R^{A})-alk-, —C(O)—O-alk-, -alk-C(O)—O—, -alk-C(O)—O-alk-, —C(O)-alk-, -alk-C(O)-alk-, —C(R^{A})═C(R^{A})—, -alk-C(R^{A})═C(R^{A})—, -alk-C(R^{A})═C(R^{A})-alk-, —C≡C—, -alk-C≡C—, and -alk-C≡C-alk-,

wherein: alk is a substituted or unsubstituted C₁₄ alkylene group; ary is a substituted or unsubstituted arylene group; and each R^{A} is independently a substituent selected from H, substituted or unsubstituted C₁₋₈ alkyl and substituted or unsubstituted aryl. alk is typically an unsubstituted C₁₋₃ alkylene group, for instance methylene(methanediyl), ethylene or propylene.

For instance, each L¹ and each L² may be independently selected from an unsubstituted C₁₄ alkylene group, an unsubstituted C₄₋₈ cycloalkylene group, an unsubstituted phenylene group and groups of formula -alk-ary-, -alk-ary-alk-, —O-alk-, —O-alk-O—, -alk-O-alk-, -alk-O-alk-O—, -alk-N(R^{A})—, -alk-N(R^{A})-alk, —C(O)—N(R^{A})-alk-, -alk-C(O)—N(R^{A})—, -alk-C(O)—N(R^{A})-alk-, —C(O)—O-alk-, -alk-C(O)—O—, -alk-C(O)—O-alk-, —C(O)-alk-, and -alk-C(O)-alk-, wherein: alk is an unsubstituted C₁₄ alkylene group; ary is an unsubstituted phenylene group; and each R^{A} is independently a substituent selected from H and unsubstituted C₁₋₈ alkyl.

More typically, each L¹ and each L² are independently selected from an unsubstituted C₁₋₄ alkylene group, an unsubstituted C₄₋₈ cycloalkylene group, and groups of formula -alk-ary-, -alk-ary-alk-, —O-alk-, —O-alk-O—, -alk-O-alk-, -alk-O-alk-O—, -alk-N(R^{A})—, -alk-N(R^{A})-alk-, —C(O)—N(R^{A})-alk-, -alk-C(O)—N(R^{A})—, -alk-C(O)—N(R^{A})-alk-, —C(O)—O-alk-, -alk-C(O)—O—, -alk-C(O)—O-alk-, —C(O)-alk-, and -alk-C(O)-alk-, wherein: alk is an unsubstituted C₁₋₄ alkylene group; ary is an unsubstituted phenylene group; and each R^{A} is independently a substituent selected from H and unsubstituted C₁₋₈ alkyl, or from a group of formulae

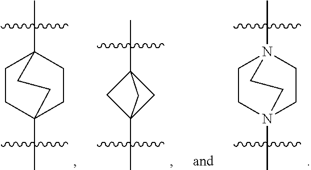

For instance, each L¹ and each L² may be independently selected from a direct bond, a substituted or unsubstituted C₁₋₄ alkylene group and a substituted or unsubstituted C₄₋₈ cycloalkylene group. Thus, each L¹ and each L² may be independently selected from a substituted or unsubstituted C₁₋₄ alkylene group and a substituted or unsubstituted C₄₋₈ cycloalkylene group. An example of an unsubstituted C₄₋₈ cycloalkylene group is bicyclo[2.2.2]octane-1,4-diyl.

Typically, each L¹ and each L² is independently methylene, ethylene, propylene or butylene. Each L¹ and each L² may for instance be selected from methylene, ethylene and propylene. Preferably, each L¹ is methylene or ethylene; and each L² is methylene or ethylene. For instance, each L¹ may be methylene and each L² may be methylene.

Particular Compounds

Typically compounds of formula (A) comprise:
an Acc group selected from:

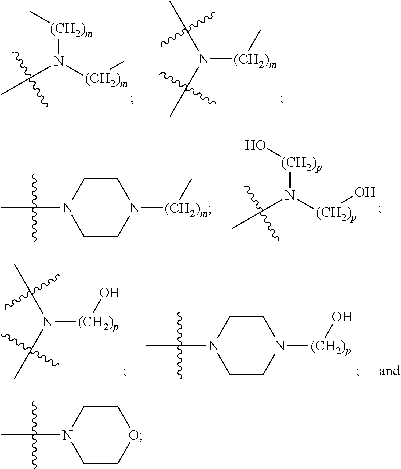

wherein:
m is an integer from 0 to 8;
p is an integer from 1 to 8; and
each [symbol] in Acc represents a bond to an L¹;
a Fluo group which is a fluorophore selected from moieties of the following formulae:

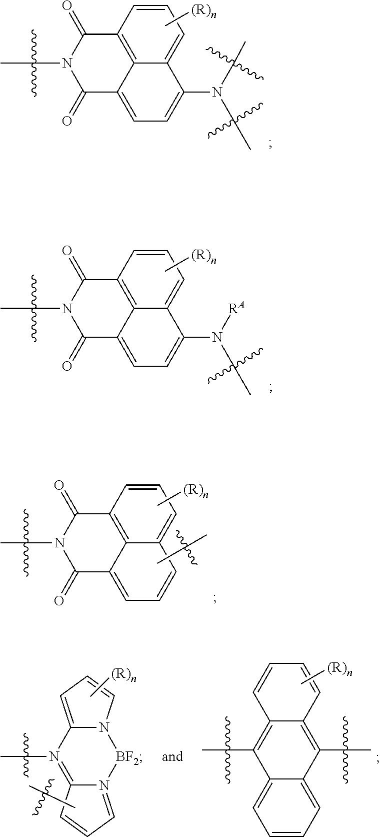

wherein:
each R is independently a substituent selected from OH, NH₂, halo, unsubstituted C₁₋₈ alkyl, unsubstituted C₁₋₈ alkoxy, unsubstituted C₁₋₈ alkylamino, unsubstituted C₁₋₈ dialkylamino, unsubstituted C₁₋₈ monohydroxyalkyl and phenyl;
R^{A} is a substituent selected from H, unsubstituted C₁₋₈ alkyl, unsubstituted C₁₋₈ monohydroxyalkyl and phenyl;
n is an integer from 0 to 6; and
each [symbol] in Fluo represents a bond to either an L¹ or an L²; and

a Redox group which is selected from moieties of the following formulae:

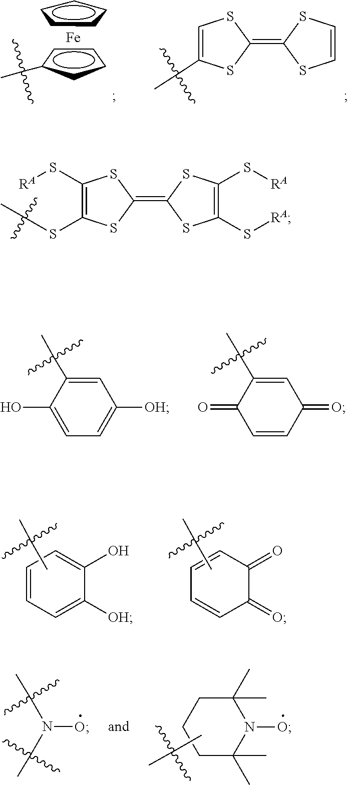

wherein:
R^{A} is a substituent selected from H, unsubstituted C₁₋₈ alkyl, unsubstituted C₁₋₈ monohydroxyalkyl and phenyl; and
each [symbol] in Redox represents a bond to an L².

The compound of formula (A) is often of formula (B), (B2), (C), (D), (E) or (F):

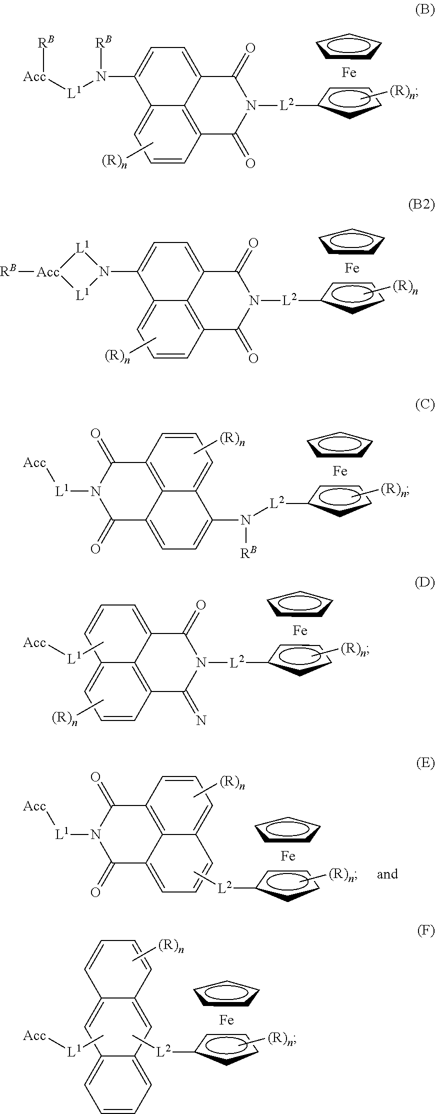

wherein:
Acc is as defined herein;
each L¹ and each L² is as defined herein;
each R is independently a substituent selected from OH, NH₂, halo, unsubstituted C₁₋₈ alkyl, unsubstituted C₁₋₈ alkoxy, unsubstituted C₁₋₈ alkylamino, unsubstituted C₁₋₈ dialkylamino, unsubstituted C₁₋₈ monohydroxyalkyl and phenyl;
R^{A} is a substituent selected from H, unsubstituted C₁₋₈ alkyl, unsubstituted C₁₋₈ monohydroxyalkyl and phenyl;
each R^{B} is independently a substituent selected from H, unsubstituted C₁₋₈ alkyl and unsubstituted C₁₋₈ monohydroxyalky, and where two R^{B} groups may be bonded together to form an unsubstituted C₁₋₄ alkylene group; and
n is an integer from 0 to 4.

For instance, the compound of formula (A) may be a compound of formula (G):

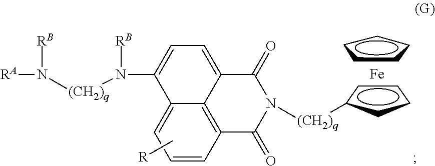

wherein:
R is a substituent selected from H, OH, NH₂, halo, unsubstituted C₁₋₈ alkyl, unsubstituted C₁₋₈ alkoxy, unsubstituted C₁₋₈ alkylamino, unsubstituted C₁₋₈ dialkylamino, unsubstituted C₁₋₈ monohydroxyalkyl and phenyl;
R^{A} is a substituent selected from H, unsubstituted C₁₋₈ alkyl, unsubstituted C₁₋₈ monohydroxyalkyl and phenyl;
each R^{B} is independently a substituent selected from H, unsubstituted C₁₋₈ alkyl and unsubstituted C₁₋₈ monohydroxyalky, and where the two R^{B} groups may be bonded together to form an unsubstituted C₁₋₄ alkylene group; and
each q is independently 1, 2 or 3.

For instance, in formula (G), R may be a substituent selected from H, OH, NH₂, halo, unsubstituted C₁₋₄ alkyl, unsubstituted C₁₋₄ alkoxy, unsubstituted C₁₋₄ alkylamino, unsubstituted C₁₋₄ dialkylamino, unsubstituted C₁₋₄ monohydroxyalkyl and phenyl;
R^{A} may be a substituent selected from H, unsubstituted C₁₋₄ alkyl and unsubstituted C₁₋₄ monohydroxyalkyl;
each R^{B} may be independently a substituent selected from H and unsubstituted C₁₋₄, and the two R^{B} groups may be bonded together to form an unsubstituted C₁₋₄ alkylene group; and each q may be independently 1 or 2.

Preferably, the compound of formula (A) is of formula (H), (I) and (J):

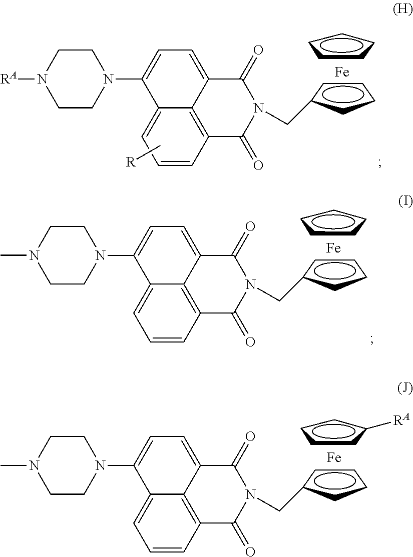

wherein:
R is a substituent selected from H, OH, NH₂, halo, unsubstituted C₁₋₈ alkyl, unsubstituted C₁₋₈ alkoxy, unsubstituted C₁₋₈ alkylamino, unsubstituted C₁₋₈ dialkylamino, unsubstituted C₁₋₈ monohydroxyalkyl and phenyl; and
R^{A} is a substituent selected from H, unsubstituted C₁₋₈ alkyl, unsubstituted C₁₋₈ monohydroxyalkyl and phenyl.

The compounds of formula (A) according to the invention are often at least partly soluble in water. Typically therefore, the compound of formula (A) has a water solubility of greater than or equal to 0.01 mg/ml at 20° C., or greater than or equal to 0.1 mg/ml at 20° C.

The compound of formula (A) may in some cases be attached to a solid support. For example, the compound of formula (A) may be attached to a solid support by a third spacer group L^{x} (which may be as defined for L¹ or L² above). The solid support is typically a polymeric support. An example of a compound of formula (A) attached to a solid support is a compound of formula (X) or formula (Y):

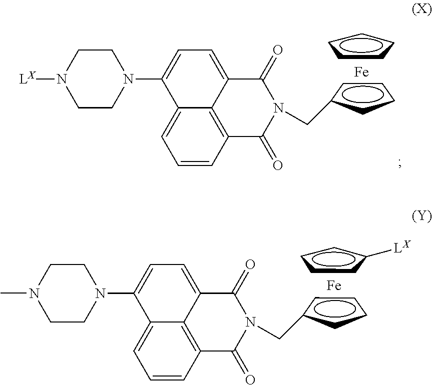

wherein L^{x} is said spacer group which is attached to the solid support.

Method

The method according to the invention of measuring the acidity and redox potential of a sample comprises:
(i) contacting a compound of formula (A) with the sample;
(ii) exposing the sample to a light source, measuring fluorescence and thereby determining the acidity and redox potential of the sample.

Measuring the acidity and redox potential of a sample includes detecting the presence or absence of acidity and redox potential in a sample.

Often, measuring the acidity and redox potential of a sample involves determining whether the acidity exceeds a certain threshold value (e.g. is below a certain pH) and the redox potential exceeds a certain threshold value (e.g. is above a certain pE (redox potential)). The compounds of formula (A) act as molecular AND logic gates that return a significant output when inputs are received by both Acc and Redox. Thus, the method can allow the determination of the presence or absence of both acidity (i.e. an acidity exceeding a certain value) and redox potential (i.e. a redox potential exceeding a certain value). The point at which the compound (A) “switches”, i.e. the point at which it fluoresces, as regards acidity and redox potential can be varied by changing the identity of Acc and Redox. For instance, some compounds of formula (A) may be designed to fluoresce when exposed to both relatively low acidity (e.g. pH less than 7) and relatively low redox potential (e.g. equal to or lower than 0.5 V versus SCE in aqueous solution). Alternatively, some compounds of formula (A) may be designed to fluoresce when exposed to both relatively high acidity (e.g. pH less than 3) and relatively high redox potential (e.g. equal to or lower than 1.5 V vs SCE in aqueous solution). Less basic Acc groups can be used to produce compounds of formula (A) which require higher acidity (lower pH) in order to fluoresce. Less easily oxidised Redox groups can be used to produce compounds of formula (A) which require more oxidising environments to fluoresce.

The detection of redox potential often comprises detecting the presence or absence of redox active species in the sample, for instance, metal ions, but also organic molecules, radical species, and proteins. Often, the method of the invention may be used to measure the acidity of a sample and the presence of one or more oxidising species in the sample (for instance Fe³⁺ ions).

Examples of the applicability of the method of the invention include:

Corrosion science: for example in the form of a spray on vehicles (automobiles, ships, airplanes), and metal infrastructure, which would give an early warning sign for corrosion of materials, such as the presence of rust, before rust is visible with the human eye.

Geochemistry: analysis of ores, soil samples or waste from mining sites.

Water maintenance: sewage and ground water testing, and testing of lakes affected by acid rain.

Water quality: a bad taste is often due to metal ions, such as iron (III) and copper (II) in acidic water. The method of the invention may be used to detect these conditions.

Biotechnology: high proton and high iron (III) levels have been linked to various cancers, such as colorectal and liver cancer. For example, low intracompartmental pH in vesicles plays a key role in the activity of enzymes—such as ferric ion release from transferrin at pH 5.5.

Molecular biology: for instance as molecular probes for identifying and studying the mitochondria in living (and cancer) cells. The sensor compounds proposed here may preferentially be taken up by the mitochondria over the lysosome.

Other applications include: molecular diagnostics; molecular computation and information processing, nanotechnology and optoelectronic devices.

Typically, step (i) of contacting a compound of formula (A) with the sample comprises forming a composition comprising the sample and the compound of formula (A), wherein the concentration of the compound of formula (A) in the sample may be from 0.01 nM to 10 mM. Contacting the compound of formula (A) with the sample typically comprises adding the compound of formula (A) to the sample. The concentration of compound (A) in the sample is typically from 0.1 nM to 10 mM.

The sample typically comprises one or more solvents. The solvents may be any suitable solvents. For instance, the one or more solvents may be selected from water and one or more organic solvents. Typically, the one or more solvents are selected from organic solvents. Examples of polar and non-polar solvents include water, alcohol solvents (such as methanol, ethanol, n-propanol, isopropanol and n-butanol), ether solvents (such as dimethylether, diethylether and tetrahydrofuran), ester solvents (such as ethyl acetate), ketone solvents (such as acetone), amide solvents (such as dimethylformamide and diethylformamide), amine solvents (such as triethylamine), nitrile solvents (such as acetonitrile), sulfoxide solvents (dimethylsulfoxide) and halogenated solvents (such as dichloromethane, chloroform, and chlorobenzene). Often, the one or more solvents are selected from water and alcohol solvents. For instance, the one or more solvents may be water, or the one or more solvents may be two solvents which are water and methanol (for instance water and methanol in a volume ratio of from 4:1 to 1:4).

In some cases, the sample may comprise greater than or equal to 5% of water by volume relative to the total volume of the sample. For instance, the sample may comprise greater than or equal to 10% of water by volume, or greater than 20% of water by volume, relative to the total volume of the sample.

In step (ii), “exposing the sample to a light source” usually comprises exposing the sample to a UV light source. Other light sources may however be suitable, for instance visible or infra-red. “Measuring fluorescence” may comprise measuring the intensity of fluorescence, which may be done by using a fluorescence detector, e.g. by performing fluorescence spectroscopy. Alternatively, “measuring fluorescence” may comprise observing the presence or absence of fluorescence upon exposure to the light source. “Observing the presence or absence of fluorescence” may, for instance, be done by human eye. The term “absence of fluorescence” does not necessarily imply that there is a complete absence of fluorescence, but typically means that there is no noticeable fluorescence, for instance when compared with the fluorescence of compound (A) in the presence of both acidity or redox potential.

Determining the acidity and redox potential of the sample usually means determining whether or not the acidity of the sample is greater than a certain “threshold” value and whether or not the redox potential of the sample is greater than a certain “threshold” value. These threshold values are usually the values above which the compound fluoresces, and so the determinations will be positive (i.e. both threshold values will be exceeded) if fluorescence is observed.

Determining the acidity and redox potential of the sample may comprise:
(a) comparing the intensity of the fluorescence to a reference value; and
(b) determining the acidity and redox potential of the sample if the measured intensity exceeds the reference value.

Here, (b) “determining the acidity and redox potential of the sample if the measured intensity exceeds the reference value”, usually means determining (i.e. concluding) that the pH of the sample is below a particular pH threshold value and that the redox potential is above a particular pE threshold value if the measured intensity exceeds the reference value.

It may, for example, mean determining (concluding) that the pH of the sample is less than 5.0 and the redox potential of the sample is greater than 0.5 V if the measured intensity exceeds the reference value. It may, on the other hand, mean that the pH of the sample is less than 3.0 and the redox potential of the sample is greater than 1.0 V, if the measured intensity exceeds a reference value. This will depend on the pH and pE threshold values of the compound of the invention, i.e. the pH value above which the molecule does not fluoresce and the pE value below which the molecule does not fluoresce). The pH and pE threshold values will, of course, depend on the nature of the Redox and Acc units, and in particular how readily those units undergo oxidation (reduction) and protonation (deprotonation), respectively. It is possible to design a sensor molecule which fluoresces below a particular desired pH threshold value and above a particular desired pE threshold value by selecting appropriate Redox and Acc units.

For example, the pH threshold value (i.e. the pH value above which the molecule does not fluoresce) may be a value which is less than or equal to pH 6.0. The pH threshold value may be less than or equal to 5.0. The pH threshold value may, for instance, be less than or equal to 4.0, less than or equal to 3.0, less than or equal to 2.0 or even less than or equal to 1.0.

Similarly, the redox potential (E) threshold value (i.e. the E+0.0591=pE value below which the molecule does not fluoresce) may be a value which is greater than or equal to 0.4 V. The redox potential threshold value may for instance be greater than or equal to 0.5 V, or for example greater than or equal to 1.0 V. It may for instance be greater than or equal to 1.5 V, greater than or equal to 2.0 V, or for example greater than or equal to 2.5 V.

Thus, usually, the pH threshold value is less than or equal to 6.0 and the redox potential threshold value is greater than or equal to 0.4 V. The pH threshold value may however be less than or equal to 5.0 and the redox potential threshold value may be greater than or equal to 0.5 V. Often, for example, the pH threshold value is less than or equal to 4.0, and the redox potential threshold value is greater than or equal to 1.0 V. Thus, for example, the pH threshold value may be less than or equal to 3.5, and the redox potential threshold value may be greater than or equal to 1.5 V. The pH threshold value may for instance be less than or equal to 3.0, and the redox potential threshold value may be greater than or equal to 2.0 V. For instance, the pH threshold value may be less than or equal to 2.5, and the redox potential threshold value may be greater than or equal to 2.0 V, or greater than or equal to 2.5 V, or for instance greater than or equal to 3.0 V. The pH threshold value may, for example, be less than or equal to 2.0, and the redox potential threshold value may be greater than or equal to 2.0 V (or greater than or equal to 2.5 V, or for instance greater than or equal to 3.0 V). Similarly, the pH threshold value may be less than or equal to 1.5, or for instance less than or equal to 1.0, and the redox potential threshold value may be greater than or equal to 2.0 V

The pH threshold value is often from 1.0 to 7.0, and the redox potential threshold value is usually from 0.4 V to 2.0 V (pE from 13 to 35). The pH threshold value may, for instance, be from 1.0 to 5.0, and the E threshold value may be from 0.8 V to 2.0 V, or for example from 1.0 V to 2.0 V. Thus, the pH threshold value may be from 1.0 to 5.0, and the E threshold value from 0.5 V to 2.0 V. Often, for example, the pH threshold value is from 1.5 to 4.5, or for instance from 2.0 to 4.0 and the E threshold value is from 0.8 V to 2.0 V.

pH is defined as pH=−log [H₃O⁺], which ranges from 0 to 14 in water.

pE is defined as pE=−log aₑ, which normally ranges from 12 to 25 for pE in water. It may also be defined as pE=E/0.0591 under standard conditions of unit activities, which corresponds to a typical range of −0.7 V to +1.5 V.

Accordingly, in the method of the invention, step (ii) may comprise: exposing the sample to said light source, measuring the intensity of the fluorescence, comparing the intensity of the fluorescence to a reference value, and determining that the pH of the sample is below a pH threshold value and that the redox potential of the sample is above a pE threshold value if the measured intensity of the fluorescence exceeds the reference value.

The pH and pE threshold values in this embodiment may be as defined anywhere hereinbefore.

Determining the acidity and redox potential may simply comprise observing (by eye) the presence of fluorescence and thereby determining the presence of both acidity below a certain pH threshold value and redox potential above a certain pE threshold value. Accordingly, in another embodiment, step (ii) of the method of the invention comprises: exposing the sample to said light source, observing the presence or absence of fluorescence and determining that the pH of the sample is below a pH threshold value and that the redox potential of the sample is above a pE threshold value if fluorescence is present.

Again, the pH and pE threshold values may be as defined above.

Compounds

The invention also provides a compound of formula (A):

Acc(-L¹-)ₐFluo(-L²-)_{b}Redox (A);
wherein:
   Acc is a proton acceptor moiety;
   Fluo is a fluorophore;
   Redox is a redox unit;
   each L¹ is a first spacer group which is bonded to Acc and Fluo;
   each L² is a second spacer group which is bonded to Fluo and Redox;
   a is 1 or 2; and
   b is 1 or 2.

The compound of the invention may be as further defined for a compound of formula (A) in the method of the invention. Acc may be as defined hereinbefore. Fluo may be as defined hereinbefore. Redox may be as defined hereinbefore. Each L¹ may be as defined hereinbefore. Each L² may be as defined hereinbefore.

Often, the compound of formula (A) according to the invention is a compound of formula (H), (I) or (J):

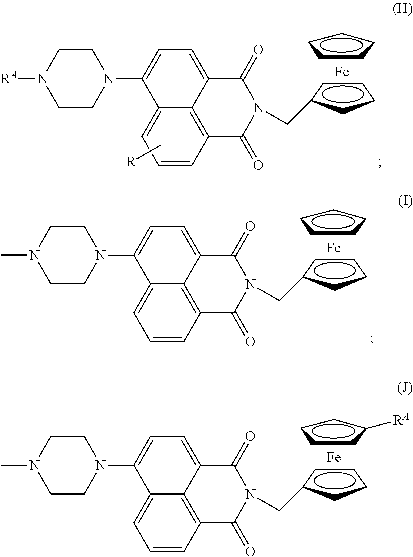

wherein:
R is a substituent selected from H, OH, NH₂, NO₂, halo, unsubstituted C₁₋₈ alkyl, unsubstituted C₁₋₈ alkoxy, unsubstituted C₁₋₈ alkylamino, unsubstituted C₁₋₈ dialkylamino, unsubstituted C₁₋₈ monohydroxyalkyl and phenyl; and
R^{A} is a substituent selected from H, unsubstituted C₁₋₈ alkyl, unsubstituted C₁₋₈ monohydroxyalkyl and phenyl.

The compound may for instance be a compound of formula (I) as discussed in the forthcoming section.

Process for Producing Compounds

The compounds of the invention are typically produced by (a) coupling a compound comprising Redox with a compound comprising Fluo, or a precursor compound to Fluo, to produce Fluo(-L²-)_{b}Redox and (b) coupling a compound comprising Acc with Fluo(-L²-)_{b}Redox to produce Acc(-L¹-)ₐFluo(-L²-)_{b}Redox. Alternatively the compounds may be produced by (a) coupling a compound comprising Acc with a compound comprising Fluo, or a precursor compound to Fluo, to produce Acc(-L¹-)ₐFluo and (b) coupling a compound comprising Redox with Acc(-L¹-)ₐFluo to produce Acc(-L¹-)ₐFluo(-L²-)_{b}Redox.

For instance, compounds of formula (A) comprising a 4-amino-1,8-naphthalimide Fluo group may be produced by one of the following general schemes.

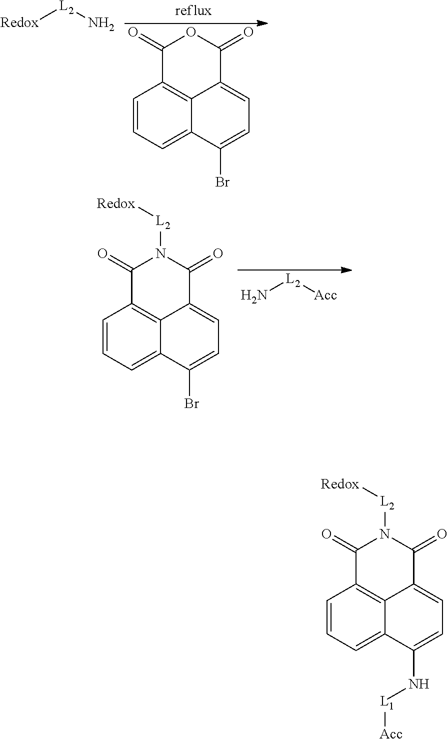

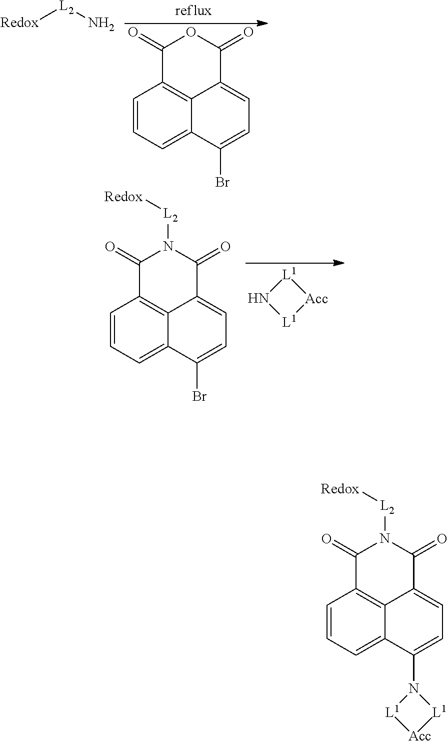

If the fluorophore does not comprise a heteroatom (for instance if the fluorophore is anthracene), Redox and Acc can be coupled to anthracene using known coupling reactions suitable for coupling aromatic compounds to form carbon-carbon bonds. Examples of such coupling reactions include the Heck reaction, the Stille reaction, the Suzuki reaction and Hiyama coupling.

Use

The invention also provides use of a compound of formula (A) for measuring acidity and redox potential of a sample:

Acc(-L¹-)ₐFluo(-L²-)_{b}Redox (A);
wherein:
   Acc is a proton acceptor moiety;
   Fluo is a fluorophore;
   Redox is a redox unit;
   each L¹ is a first spacer group which is bonded to Acc and Fluo;
   each L² is a second spacer group which is bonded to Fluo and Redox;
   a is 1 or 2; and
   b is 1 or 2.

In the use according to the invention, measuring the acidity and redox potential of the sample typically comprises performing a method as further defined herein for a method according to the invention. The compound of formula (A) may be as defined hereinbefore.

The invention will now by described in more detail by the following examples.

### EXAMPLES

A molecular sensor according to the invention, compound 5, was synthesised and characterised using standard techniques as described below. Compound 5 has the following molecular structure.

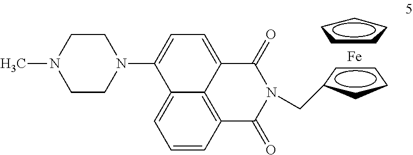

1.1 Synthesis and Characterisation

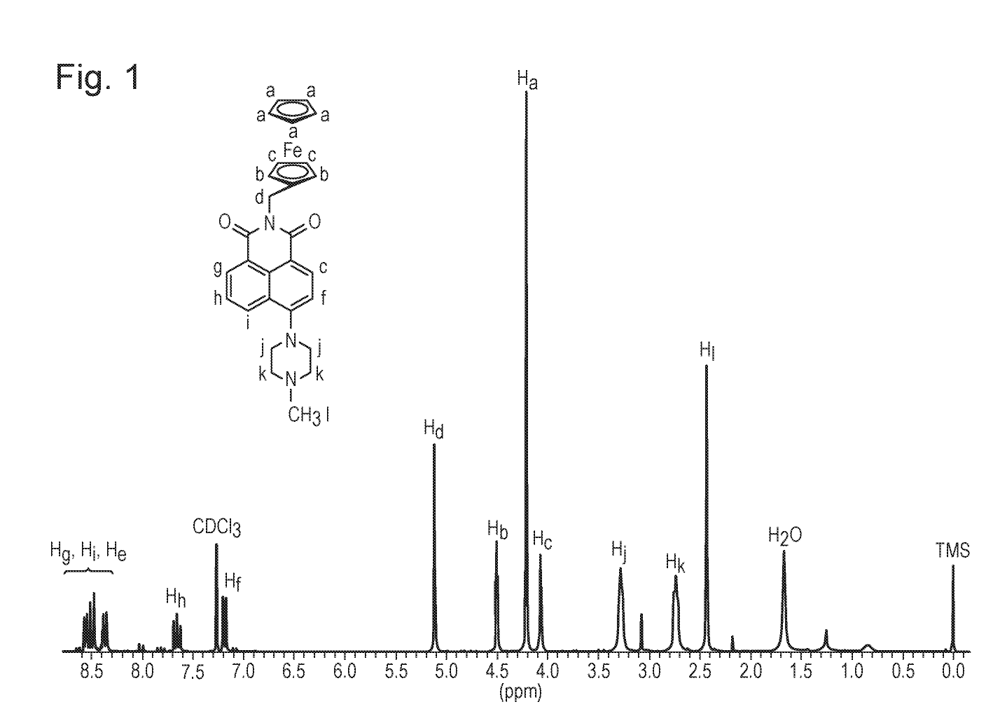

The naphthalimide-based logic gate compound 5 was synthesized via a three-step strategy. Firstly, reductive amination of ferrocenecarboxaldehyde 6 in the presence of hydroxylamine and lithium aluminium hydride resulted in the formation of ferrocenylmethylamine 7 in 41% yield. Secondly, the reagent 4-bromo-1,8-naphthalic anhydride was then reacted with compound 7 to obtain the intermediate compound 8 via a condensation reaction in 34% yield. The final step is an aromatic nucleophilic substitution involving 8 with 1-methylpiperazine by substitution of the bromine moiety to yield the desired product compound 5 in 72% yield. The crude product 5 was collected by precipitation from the reaction mixture using cold water, and subsequently recrystallised from 1:1 (v/v) ethanol:water and recovered as a yellow solid. Each reaction step was monitored using thin-layer chromatography. Detailed experimental procedures are given in section 3 below. The final product was characterized by ¹H NMR, ¹³C NMR, infra-red, UV-visible and fluorescence spectroscopy. Supporting spectra are given as FIGS. 1-6 at the end of the document.

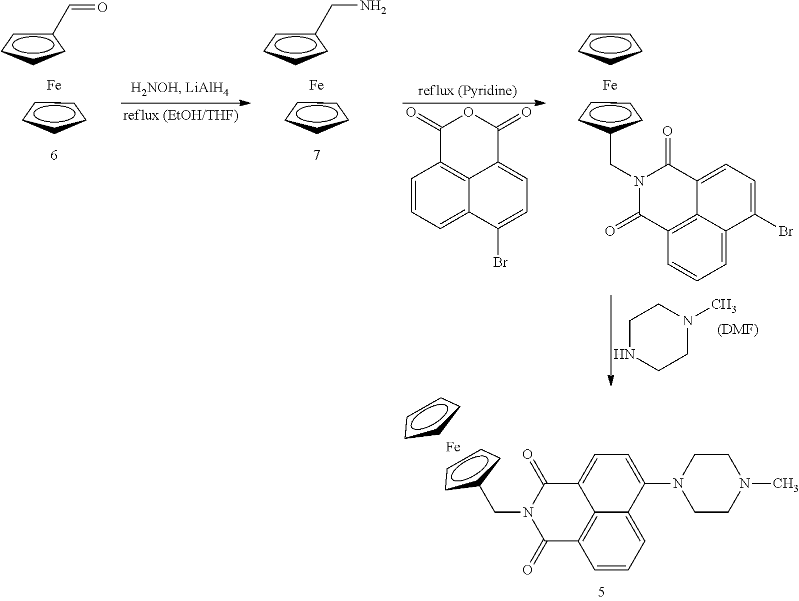

1.1.1 Characterization of 5 by ¹H NMR and ¹³C NMR Spectroscopy

The ¹H NMR spectrum of compound 5 has 12 distinct chemical shifts accounting for 27 proton nuclei. As shown in FIG. 1, the peaks cover a chemical shift range from 0 to 8.5 ppm. The signals are found into three main regions: the methylene and methyl proton signals are situated in the low frequency region (2.0-3.0 ppm), the ferrocene proton signals are situated in the mid-frequency region (4.0-5.5 ppm) whilst the high frequency region (7.0-9.0 ppm) contains the naphthalimide proton signals. The singlet at 2.42 ppm corresponds to the methyl group situated on the methylpiperazine. The two broad signals at 2.73 and 3.28 ppm are the four methylene protons on the spacers of the methylpiperazine ring. The three signals between 4.0 and 4.5 ppm are characteristic of the ferrocene moiety. The five equivalent protons on the unsubstituted cyclopentadiene ring produce the singlet at 4.20 ppm. The four protons found on the other cyclopentadiene ring are represented by two signals at 4.50 and 4.07 ppm. The observed sharp singlet at 5.11 ppm corresponds to the protons situated on the methylene bridge between the ferrocene and the naphthalimide groups. Further downfield, the signals are due to the naphthalinic group. The proton labelled Hh gives a signal at 7.65 ppm and could be easily identified as a triplet since that proton is the only one that is adjacent to two non-equivalent protons. The remaining four distinguishable protons labelled Hf, He, Hi and Hg correspond to the signals recorded at 7.19, 8.37, 8.49 and 8.56 ppm, respectively. The signals were assigned based on the coupling constants measured in Hz.

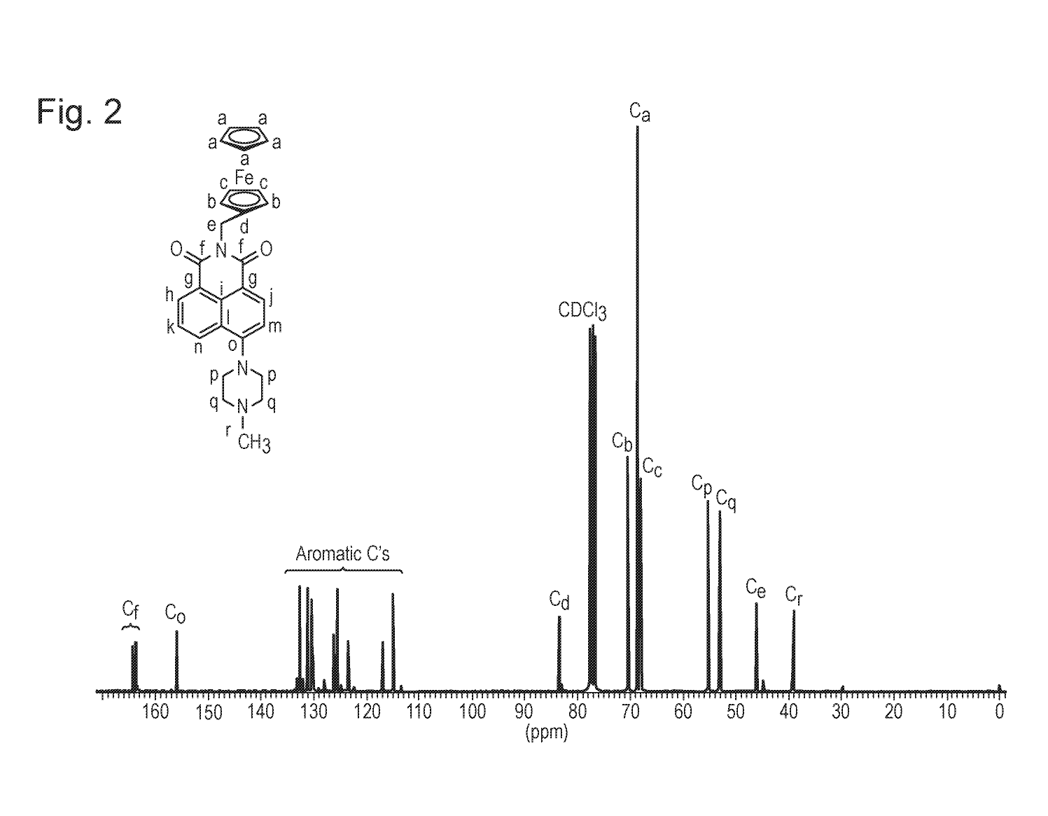

A ¹³C NMR spectrum was obtained to further characterize compound 5. A total of 19 non-equivalent carbon signals were observed. The spectrum is shown in FIG. 2. The spectrum has three regions of signals (i) covering 38 to 84 ppm, (ii) covering 112 to 135 ppm and (iii) covering 152 to 167 ppm. It is difficult to assign each signal with the corresponding equivalent carbon atoms; however, the number of signals found in a particular region could be compared to the expected number of signals in relation to the carbon atoms within compound 5. In the range between 38-84 ppm there are 8 signals, which correspond to the carbon atoms situated in the cyclopentadiene moiety, the methylpiperazine and the methylene spacer. From the 10 carbons that form the naphthalinic group, 9 signals are situated in the region between 114-134 ppm. The tenth signal labelled Cq is located at 155.9 ppm and is deshielded from the rest of the other naphthalinic carbon atoms due to the anisotropic affect caused by the neighbouring nitrogen atom. The two carbon signals at 163.7 and 164.2 ppm correspond to the two carbonyl carbon atoms.

1.1.2 Characterization of 5 by IR Spectroscopy

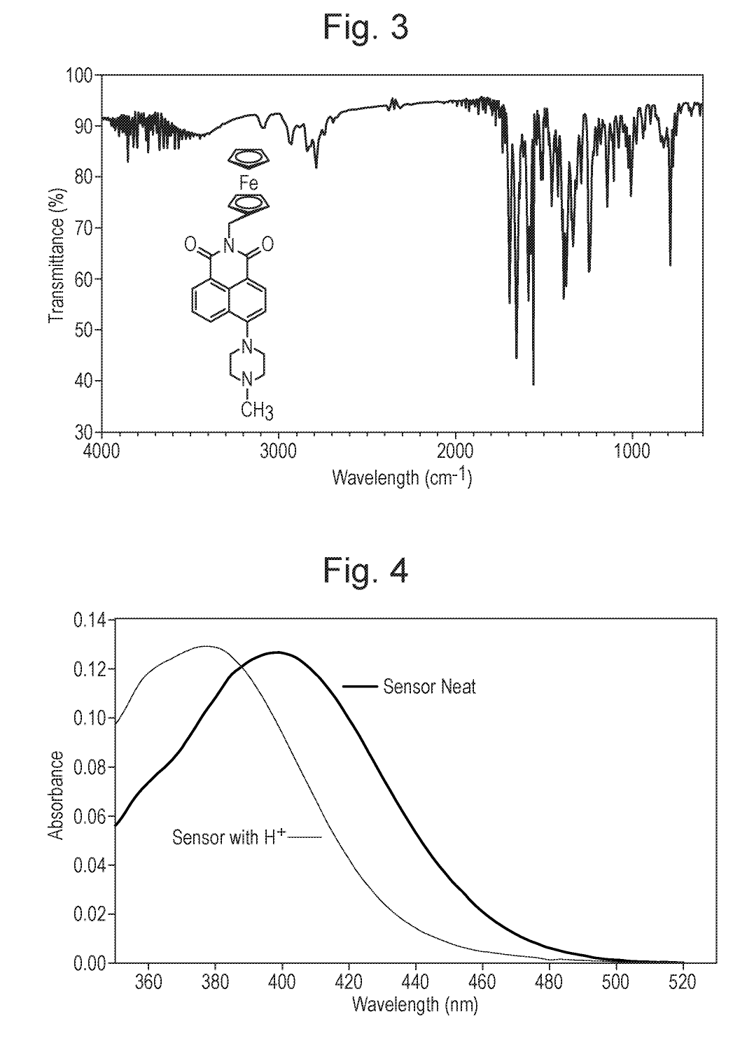

An IR spectrum of compound 5 was measured as a KBr disk. The spectrum is shown as FIG. 3. The most prominent peaks are situated at 1777 and 1682 cm⁻¹ corresponding to the C═O asymmetric and symmetric stretches, respectively. The C═C aromatic stretching (in-ring) peaks are located at 1590 and 1514 cm⁻¹ whilst the C═C aromatic stretching are evident at the 1602, 1503 and 1420 cm⁻¹ peaks. The peak at 3050 cm⁻¹ is due to the aromatic C—H whilst the three other signals between 2885-2760 cm⁻¹ are the aliphatic C—H stretches.

1.2 Spectrophotometric Results

1.2.1 UV-Vis Spectroscopy and Photophysical Properties

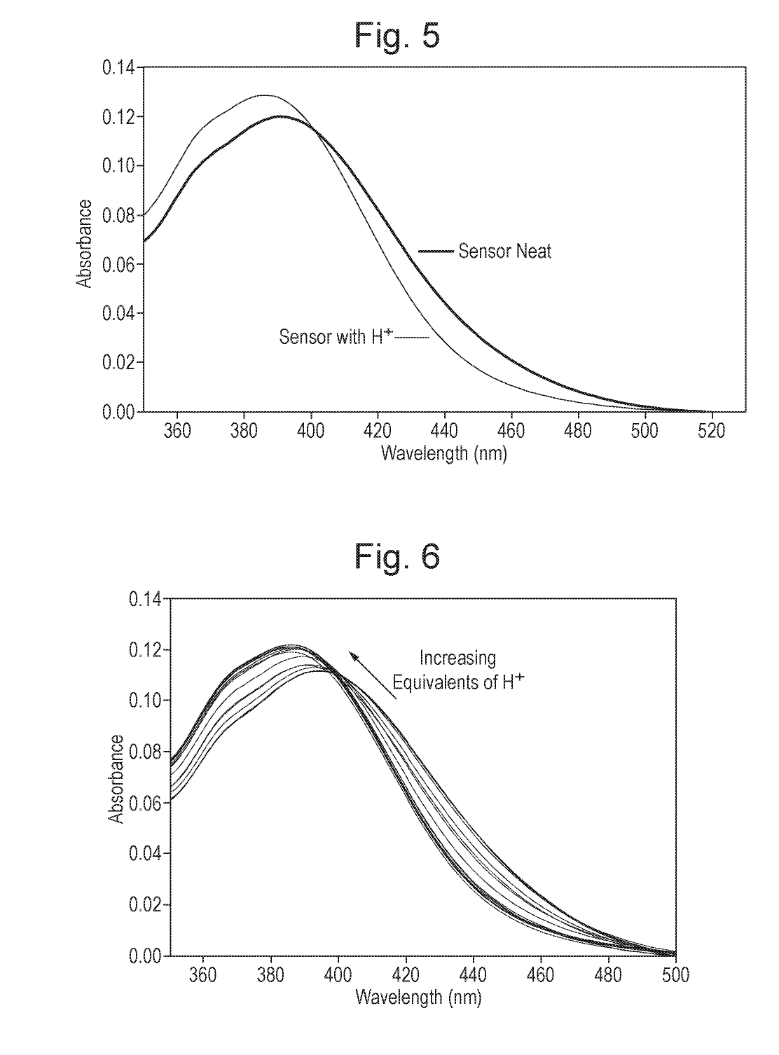

The UV-visible spectra of compound 5 were measured in methanol (FIG. 4) and 1:1 (v/v), methanol/water (FIG. 5). Characteristic broad peaks at 399 and 390 nm due to the π→π* transitions from the naphthalimide were recorded. The molar extinction coefficients of both solutions at a concentration of 1×10⁻⁵ M were determined using the Beer-Lambert law, A=ε/c, where A is the absorbance measured at a given wavelength (λₘₐₓ), l is the path length of solution through which the incident photons pass (1.0 cm), c is the molar concentration of the absorbing species and ε is the molar extinction coefficient. The results are shown in Table 1.

TABLE 1
UV-visible Absorption Parameters of 5

| | | Molar |
|---|---|---|
| Condition | λₘₐₓ/nm | extinction coefficient (ε)/L mol⁻¹ cm⁻¹ |
| MeOH | 399 | 12700 |
| MeOH with acid^{a} | 378 | 13100 |
| 1:1 MeOH/H₂O | 390 | 12000 |
| 1:1 MeOH/H₂O with | 386 | 12900 |
| acid^{a} | | |

^{a}Methanesulfonic acid with a molar concentration of 25 mM. The concentration of compound 5 was 1 × 10⁻⁵M.

UV-visible spectra of compound 5 were also carried out in an acidic environment FIGS. 4 and 5). Solutions of methanol and 1:1 (v/v) methanol/water with 1×10⁻⁵ M compound 5 in the presence of 25 mM methanesulfonic acid were used. The molar extinction coefficients range between 12000 and 13100 L mol⁻¹ cm⁻¹. The molar extinction coefficient increases slightly and the maximum wavelength also shifts to shorter wavelengths in both solutions on addition of acid. A decrease in λₘₐₓ was observed when methanesulfonic acid was added to both solutions. In the case of methanol, there was a hypsochromic shift of 21 nm whilst in 1:1 (v/v) methanol:water, only a slight hypsochromic shift of 4 nm was observed.

UV-visible spectra of 5 were also obtained in 1:1 (v/v) methanol:water solution with increasing equivalents of acid from pH 2-10 (FIG. 6). The plot shows an isosbestic point at a wavelength of 399 nm. This value was used as the excitation wavelength in the subsequent fluorescence studies.

1.2.2 Fluorescence Studies

In the first part of the fluorescence studies, the two-input AND logic functionality of compound 5 was tested via fluorescent spectroscopy using a handheld UV lamp and a spectrofluorimeter. In the second part, two different procedures were carried out to obtain physicochemical data using a spectrofluorimeter. Titrations were initially performed by titrating one input only. Afterwards, titrations were performed by titrating one input in the presence of the other input in excess. The inputs methanesulfonic acid and iron(III) sulfate. The tests were carried out in 1:1 (v/v) methanol:water. The molar concentration of compound 5 was kept at 3×10⁻⁶ M. During the fluorescence studies, UV-visible spectra were also carried out to monitor the absorbance of the resulting solutions on addition of either methanesulfonic acid and iron(III) sulfate to and ensure that an absorbance of 0.1 was not exceeded.

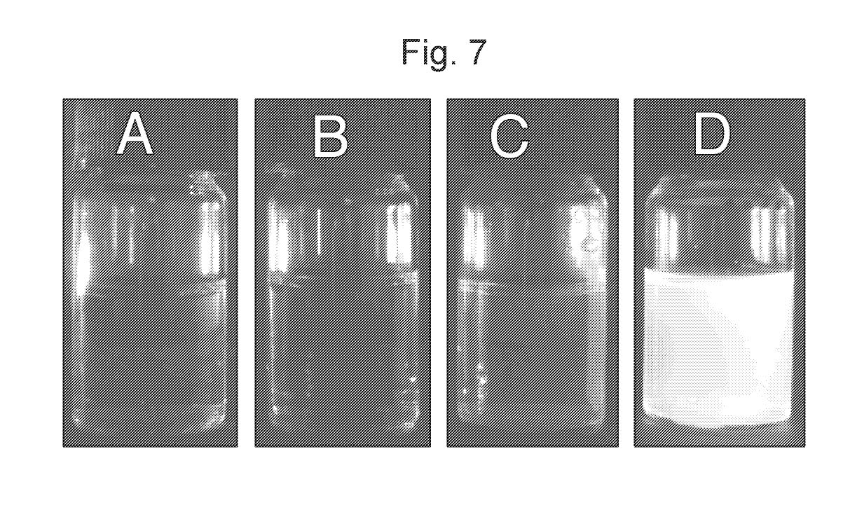

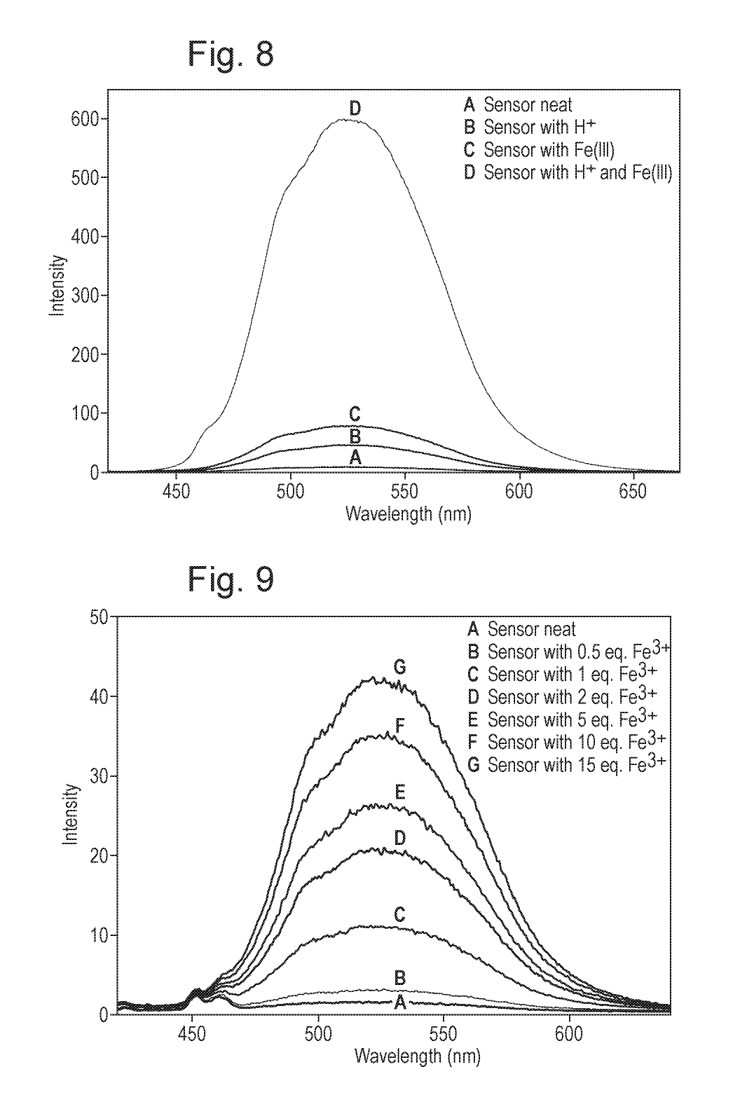

The fluorescence output according to AND logic is demonstrated in FIGS. 7 and 8. FIG. 7 shows the visual output of a solution of compound 5 under the four experimental conditions in 1:1 (v/v) methanol/water. A bright green fluorescent is only observed in the presence of high threshold concentrations of acid and Fe(III). FIG. 8 demonstrates the four experimental conditions in 1:1 (v/v) methanol/water measured with a spectrofluorimeter.

The emission output ranges between 420-670 nm. The fluorescence spectra are characterised by a broad peak centred at 525 nm In the presence of both inputs (methanesulfonic acid and Fe(III)), the fluorescence signal is significant high compared to the other three input conditions. In fact, compound 5 exhibits a remarkable 19-fold fluorescence enhancement compared to the solutions containing no inputs, or only one input, according to AND logic. Hence, compound 5 fits the definition of a Pourbaix sensor. A significant achievement is the fact that the tests were carried out in solutions of 1:1 (v/v) methanol:water solutions whereas previous experiments on compounds 1-4 (described above) were performed in organic solvents such as acetonitrile and methanol.

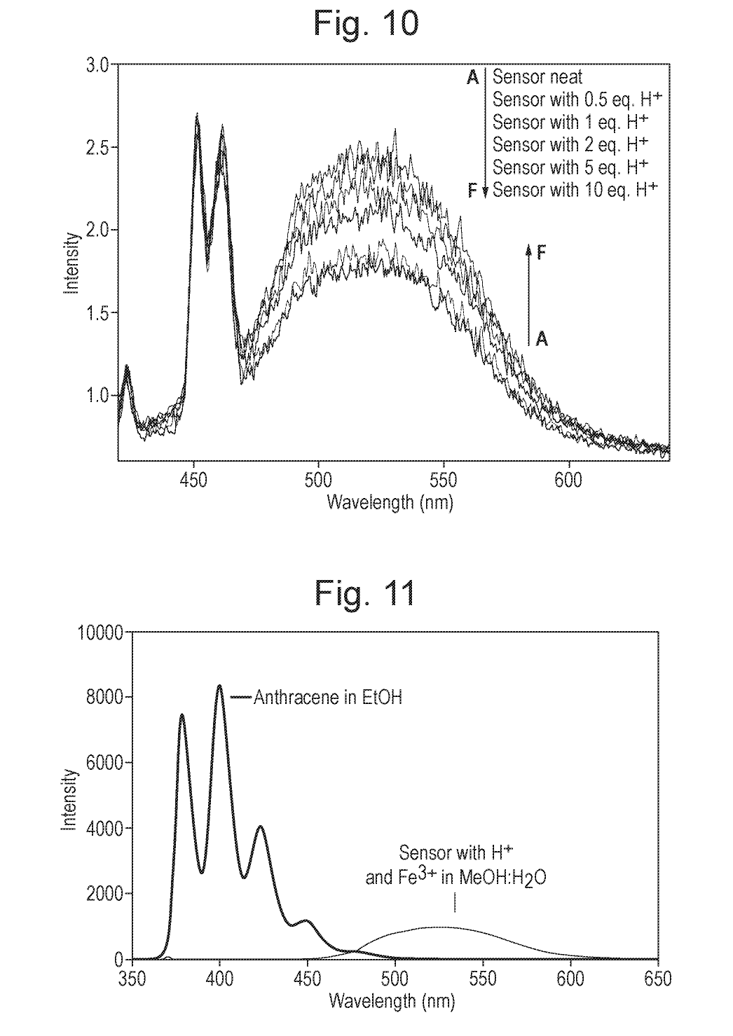

On titrating compound 5 against the oxidant and acid separately (FIGS. 9 and 10), the enhancements on the fluorescence intensity are low. In the case of methanesulfonic acid, the fluorescence output remains practically unchanged upon the addition of acid as observed from FIG. 10. The addition of the oxidant Fe(III) causes a slight increase in the fluorescence intensity, however the emission is still low compared to the intensity output given by compound 5 in the presence of both inputs (methanesulfonic acid and oxidant—iron (III)). Table 2 summarizes the four different conditions performed on compound 5, labelled A to D. Condition D represents the ‘on’ state on addition of acid and oxidant to a solution of 5 in FIG. 7. This fluorescence enhancement is clearly visible compared to the ‘off’ states of A, B and C from FIG. 7.

TABLE 2
Experimental AND Logic Input Conditions of 5

| | No. | | |
|---|---|---|---|
| Condition | of inputs | Source of inputs | Fluorescent Output |
| A | 0 | No inputs | Low |
| B | 1 | Methanesulfonic acid | Low |
| C | 1 | Iron(III) sulfate | Low |
| D | 2 | Fe(III) as titrant and H⁺ in | High |
| | | excess | |

The following scheme illustrates the various states of the sensor molecule 5 for conditions A to D tabulated in Table 2 and shown in FIG. 7.

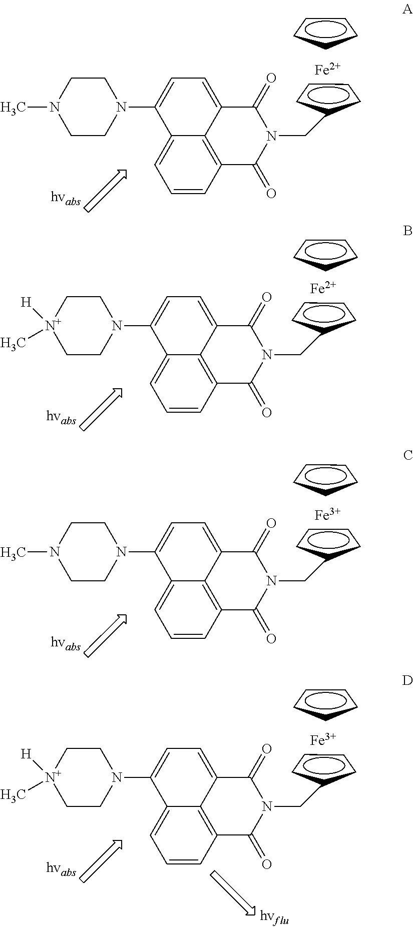

An important result from this study is that the fluorescence emission is above 450 nm Thus, interferences due to the inner-filter effect arising from the presence of free excess Fe(III) ions in solution are avoided. Furthermore, the switching from ‘off’ to ‘on’ is independent of the order the inputs are added (acid then oxidant versus oxidant then acid) to a solution of compound 5. These observations are important results because they indicate that compound 5 behaves as an ideal AND logic gate for pH and pE

1.2.3 Quantum Yields

The quantum yields of compound 5 under the four different conditions, including in the presence of either acid or oxidant, and in presence of both acid and oxidant inputs were measured. In the case of acid only, the H⁺ concentration was 0.2 mM, and for the oxidant the Fe(III) cation concentration was 10 μM. The solutions were prepared in 1:1 (v/v) methanol:water with 3×10⁻⁶ M of compound 5 whilst the relative quantum yield standard, anthracene, was 1×10⁻⁵ M (FIG. 11).

The relative fluorescence quantum yields for the four different logic combinations (conditions A to D) are shown in Table 3. A quantum yield of 0.096 (˜10%) was measured for the ‘on’ state of compound 5. This value is over an order of magnitude greater than the second highest quantum yield measurement (condition C) and represents a fluorescent enhancement factor of approximately 20. This is a significant achievement since the quantum yield of fluorescence for previously reported two-input Pourbaix sensors 2 and 3 was no greater than 2%. These results confirm that compound 5 is a state-of-the-example of a Pourbaix sensor that behaves as a two-input AND logic gate and functions as expected according to Boolean logic in mixed aqueous-methanol solution.

TABLE 3
AND Logic Truth Table and Quantum Yield Outputs

| Condition | Input 1 (H⁺)^{a} | Input 2 (Fe³⁺)^{b} | Output emission (Φ_{F})^{c} |
|---|---|---|---|
| A | 0 (low) | 0 (low) | 0 (low, 0.0003) |
| B | 1 (high) | 0 (low) | 0 (low, 0.0050) |
| C | 0 (low) | 1 (high) | 0 (low, 0.0015) |
| D | 1 (high) | 1 (high) | 1 (high, 0.096) |

^{a}High input level is 0.2 mM protons added as methanesulfonic acid. Low input level with no protons added;
^{b}High input level is 10 μM Fe(III) sulfate pentahydrate. Low input level with no added Fe(III) salt;
^{c}Output is considered high when >0.050 with uncertainty ± 10%. Quantum yields obtained by comparison with anthracene in ethanol (Φ_{f} = 0.27).

1.2.4 Proton Binding Constant and Fe(III) Binding Constant

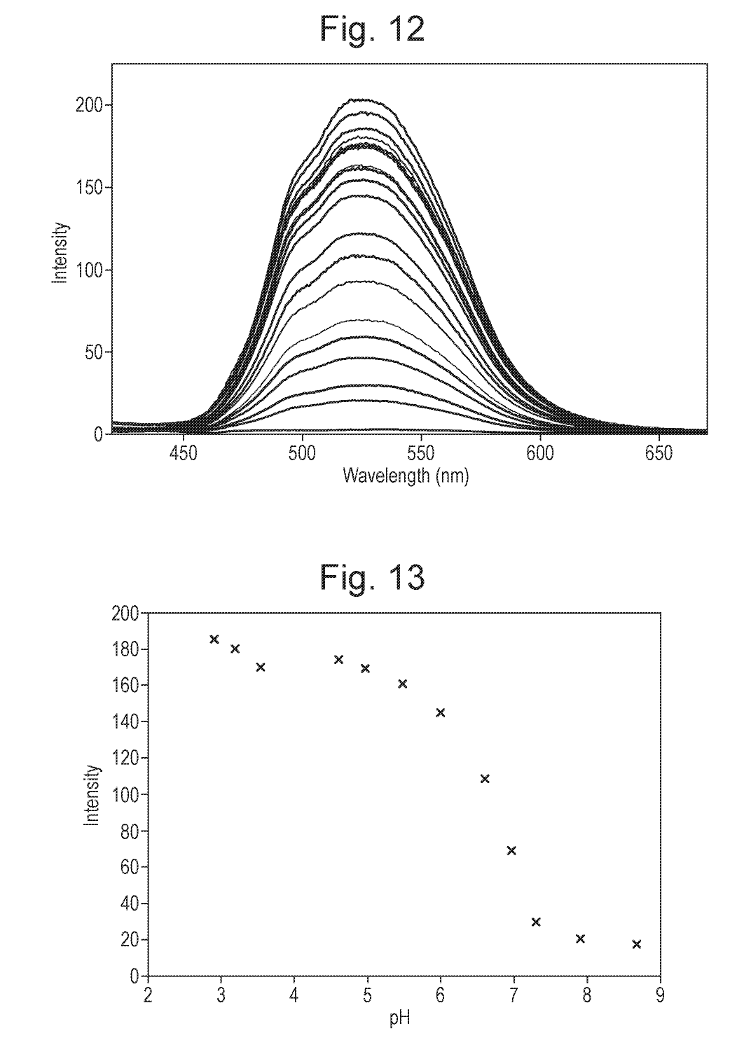

The binding of protons with the tertiary amine (receptor) and the oxidation of ferrocene (redox unit) in solution were investigated by observing the fluorescence output by titrimetric analysis. Titrations were performed by adding one input as the titrant whilst the other input had a constant concentration above the threshold requirement. FIG. 12 shows the fluorescence output increases gradually as the concentration of the acid is increased in the presence of constant excess Fe(III). In the case of the acid titration, the concentration of H⁺ was conveniently monitored by a pH meter in 1:1 (v/v) methanol:water. The maximum emission (λₘₐₓ) output corresponded to the wavelength of 525 nm. A titration curve was plotted using the fluorescence intensity as a function of pH as shown in FIG. 13. Consequently, the Henderson-Hasselbalch equation (1) was employed in a logarithmic form

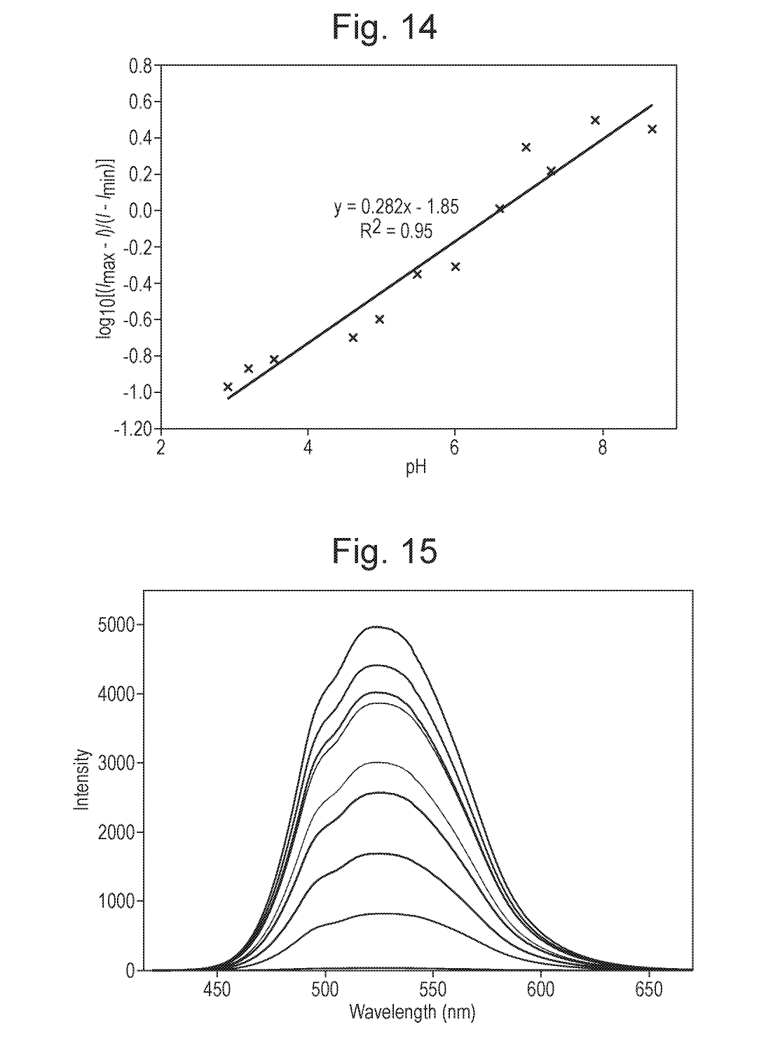

log [I_{F}_{ₘₐₓ}−I_{F})/(I_{F}−I_{F}_{ₘᵢₙ})]=pH−pKₐ (1)

where I_{F}_{ₘₐₓ}, I_{F}_{ₘᵢₙ} and I are intensities of the maximum, minimum and observed fluorescence emission observed. The resulting plot is shown in FIG. 14.

FIG. 12 illustrates the increase in fluorescence intensity output as the pH of the solution is lowered (higher H⁺ concentration). The plot also confirms that the presence of acid does not introduce any new emission bands, but only enhances the fluorescence output centred at 525 nm. This is a desirable property for an ideal fluorescence AND logic gate.

The titration plot FIG. 13 indicates that the pH curve is sigmoidal between pHs of 5.5-7.0. The change in the maximum intensity varies most sharply at a pH about 6.5 even though the actual intensity is weaker. The plot shows a plateau feature between pH 3.5-5.5 indicating the protonation of the tertiary amine (proton receptor). In this pH range, photoinduced electron transfer (PET) from the proton receptor to the fluorophore is prevented and hence fluorescence emerges, provided that the PET from the ferrocene had already been quenched. The regression analyses performed on the data set is plotted in FIG. 14. A pKₐ of 6.6 was evaluated for the protonated tertiary amine. This pKₐ value is appropriate for logic gate 5 to be potentially employed as an intramolecular pH fluorescence probe in lysosomes of eukaryotic cells.

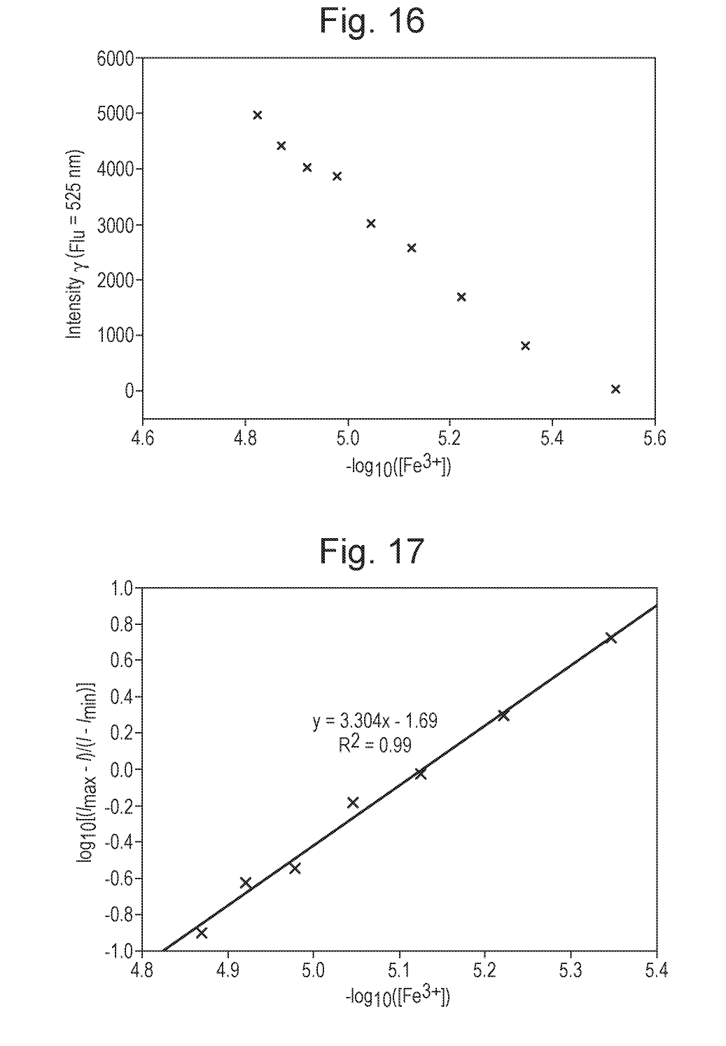

The effect of Fe(III) concentration on the fluorescence intensity was investigated in a similar way as for H⁺. Known amounts of Fe(III) were added to solutions containing compound 5 and in the presence of excess acid (FIG. 15). The resulting intensities were measured and plotted against the Fe(III) concentrations as shown in FIG. 16.

Analogues to the acid titration, a titration curve and a modified Henderson-Hasselbalch graph were plotted to investigate the empirical relationship between the intensity output as a function of Fe(III) concentration resulting from oxidisation of the ferrocene moiety. In this case, the increase in the fluorescence intensity is linear over the concentrations of Fe(III) used. The determined value for the equivalence point from FIG. 17 is −log [Fe³⁺] equals 5.1.

1.3 Comparison with Known Pourbaix Sensors

The quantum yield and fluorescence enhancement (FE) of compound 5 was compared with the known Pourbaix sensor compounds 2-4.

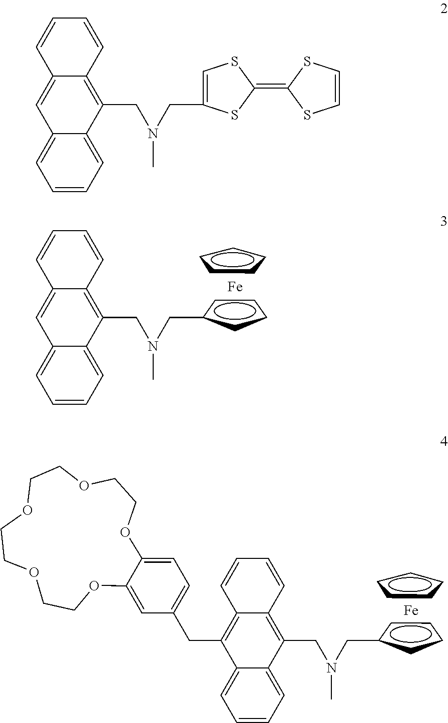

The results are shown in Table 4. The quantum yield and FE of 5 are both greatly improved compared to the known anthracene-based Pourbaix sensors. In addition, 5 was studied in mixed aqueous-methanol solution unlike 2-4, which were studied in organic solvents due to poor solubility in mixed aqueous-methanol or mixed aqueous-acetonitrile solutions.

TABLE 4
Comparison of Quantum Yields and Fluorescent Enhancement

| | | | Molar Extinction | Quantum | Fluorescent |
|---|---|---|---|---|---|
| | Solvent | Absorbance | Coefficient | Yield | Enhancement |
| Structure | mixture | nm | L cm⁻¹ mol⁻¹ | (Φ_{F}) | (FE) |
| 2 | CH₃CN | 349 | 7900 | 0.015 | 5 |
| | | 367 | 11000 | | |
| | | 387 | 9300 | | |
| 3 | MeOH | 349 | 7800 | 0.018 | 5 |
| | | 365 | 12000 | | |
| | | 386 | 11400 | | |
| 4 | MeOH | 357 | 6000 | 0.072 | 3 |
| | | 376 | 9700 | | |
| | | 397 | 9700 | | |
| 5 | MeOH:H₂O | 399 | 12000 | 0.096 | 19 |
| | (1:1) | | | | |

1.4 Conclusion

The two-input AND logic gate 5 with a novel modular design has been successfully synthesised and its sensing characteristics for protons and iron(III) studied. The synthesis of compound 5 was achieved via a three-step reaction pathway involving a reductive amination, a condensation reaction and a nucleophilic aromatic substitution. The molecule 5 is soluble in water and its spectroscopic properties remained reasonably stable. Thus, spectroscopic studies were performed in 1:1 (v/v) methanol:water solutions.

UV-visible and fluorimetric tests showed that compound 5 absorbs at a maximum wavelength of 399 nm and emits over a wavelength range of 450-600 nm with the λₘₐₓ situated at 525 nm. The fact that the fluorescence emission occurs at wavelengths greater than 400 nm avoids problems related to inner-filter effects due to Fe(III) and other potential matrix impurities. The emission output given by compound 5 under four different conditions confirmed the two-input AND logic. In the ‘on’ state the logic gate showed a remarkable quantum yield of 0.10 and an enhancement factor of 19. A pKₐ of 6.6 corresponding to the protonation of the tertiary amine (proton receptor) was determined.

The synthesis and analysis of compound 5 has results in a major improvement with respect to known Pourbaix sensors (Table 4). The novel design concept provides an increase in the Φ_{F} and FE, longer absorbance and emission wavelengths and improved solubility in aqueous media. The properties mentioned are important features for biological sensing purposes. Compound 5 has the potential to be employed in applications related to biosensing, environmental screening and corrosion science because many problems related to these areas are closely associated with the proton activity and redox environment.

2 Experimental

2.1 Instrumentation

2.1.1 Synthesis:

Reactions were conducted with a IKA C-MAG HS 7 hot plate and maintained at constant temperature monitored with an IKA ETS-D5 temperature probe. The melting points were recorded using a Stuart Griffin melting point apparatus and Fisherbrand UK thermometer (−10 to 250° C.). The apparatus was calibrated against pure samples of caffeine and vanillin.

2.1.2 Structural Determination:

¹H-NMR spectra were recorded using a Bruker AM 250 NMR spectrometer at 250.1 MHz equipped with a ¹H and ¹³C 5 mm dual probe. Samples of approximately 7 mg were dissolved in 0.8 mL of chloroform-d and the procedures were performed at room temperature. Raw data from the instrumentation were processed on a Bruker Aspect 3000 compute using 16K complex points. Chemical shifts are reported in ppm downfield from the internal reference TMS at 0.00 ppm.

The infra-red spectra were recorded using a Shimadzu IR-Affinity 1 spectrometer. The instrument was calibrated against the polystyrene absorption peak at 1602 cm⁻¹. IR analyses were done as KBr disks or as a thin film between NaCl plates depending on the sample under investigation.

2.1.3 Spectroscopic Analysis:

UV-visible spectra were recorded on a Jasco V-650 spectrophotometer connected to a desktop computer. The parameters of the instrumentation were set to medium response, a bandwidth of 2.0 nm and scan speed of 500 nm min⁻¹ Samples were scanned in the range of 350-520 nm. All spectra were corrected for the solvent by scanning the appropriate blank solvent prior to beginning the experiments setting the baseline.

Fluorimetric studies were conducted using a Jasco FP-8300 spectrophotometer connected to a desktop computer. The excitation wavelength was set at 399 nm. Bandwidths of 2.5 nm and 5.0 nm were used for the excitation and emission slits with a scan speed of 500 nm min⁻¹. The emission range was 420-670 nm, unless otherwise stated.

2.2 Synthesis

2.2.1 Synthesis of Compound 7—Ferrocenylmethylamine:

Ferrocenylmethylamine 7 was prepared via a two-step route. Initially the oxime was formed via a nucleophilic addition between the ferrocenecarboxaldehyde 6 (1.06 g, 4.95 mmol) and hydroxylamine (0.652 g, 19.8 mmol) in 30 mL ethanol. Whilst stiffing continuously, the reaction mixture was refluxed for 4 hours at 90° C. The progress of the reaction was monitored using TLC with petroleum ether and diethyl ether (3:7) as eluent. Consequently, the oxime was mixed with 50 mL of water and then extracted with dichloromethane (3×30 mL). The organic phase was dried over anhydrous MgSO₄ and the solvent was evaporated under vacuum to yield an orange powder. The amine was synthesised by reacting LiAlH₄ (0.756 g, 19.9 mmol) with the oxime dissolved in anhydrous THF (20 mL). The reaction mixture was left to reflux at 80° C. for 24 hours and monitored by TLC with petroleum ether and diethyl ether (3:7) as the eluent. The amine was observed as a yellow/orange spot on the base line. The organic phase was extracted in diethyl ether (4×30 mL) and then dried over MgSO₄. The product 7 was further purified by flash column chromatography using silica gel and eluted with ethyl acetate. The amine 7 was collected as the last yellow band. Elution was aided by the addition of a few drops of triethylamine to the ethyl acetate after the other fractions were removed. The solvent was evaporated under vacuum to give 7 as an orange oil in 41% yield.

Compound 7: ¹H-NMR (250 MHz, CDCl₃, SiMe₄, ppm): δ_{H} 1.70 (br s, 2H, NH₂), 3.55 (s, 2H, CH₂), 4.15 (m, 9H, Cp); v. (NaCl/cm⁻¹): 3366, 3298, 3092, 2965, 2926, 2857, 1636, 1558, 1541, 1456, 1449, 1437, 1105, 1037, 1022, 1001, 817.

2.2.2 Synthesis of Compound 8—N-ferrocenyl-4-bromo-1,8-naphthalimide:

4-bromo-1,8-naphthalic anhydride (0.440 g, 1.59 mmol) and 7 (0.371 g, 1.73 mmol) were dissolved in 25 mL pyridine. The mixture was stirred and refluxed at 125° C. for 18 hours. The reaction was monitored by TLC using 30:1 CH₂Cl₂/acetone. The anhydride and compound 8 gave R_{f} values of 0.76 and 0.88, respectively. Column chromatography on silica resulted in an orange solid in 34% yield.

Compound 8: m.p. 230-233° C. (dec.); ¹H-NMR (250 MHz, CDCl₃, SiMe₄, ppm): δ_{H} 8.65 (d, ¹H, J=7.3 Hz, naphthalimide), 8.52 (d, 1H, J=8.5 Hz, naphthalimide), 8.38 (d, 1H, J=7.9 Hz, naphthalimide), 8.00 (d, 1H, J=7.9 Hz, naphthalimide), 8.65 (t, 1H, J=7.3 Hz, naphthalimide), 5.12 (s, 2H, —CH₂), 4.50 (t, 2H, J=1.8 Hz, Cp), 4.22 (s, 5H, Cp), 4.09 (t, 2H, J=1.8 Hz, Cp).

2.2.3 Synthesis of Compound 5—N-ferrocenyl-4-methylpiperazine-1,8-naphthalimide:

In a 100 mL round-bottomed flask, compound 8 (0.209 g, 0.44 mmol) was dissolved in 20 mL of DMF and 1-methylpiperazine (0.250 g, 2.50 mmol). The reaction mixture was stirred at room temperature under nitrogen for 100 hours and monitored by TLC. The R_{f} of values of compounds 8 was 0.78 whilst the desired product 5 had a R_{f} of 0.10. After cooling, 150 mL of water was added to the flask resulting in a yellow solid precipitate. The crude product 5 was filtered and with cold water. Subsequently, the solid was dissolved in hot 3:2 (v/v) ethanol:water, filtered, and concentrated to 100 mL and left to cool in an ice bath. The precipitate was filtered, washed with cold water and cold diethyl ether. The desired product was collected as a yellow solid in 72% yield.

Compound 1: m.p. 170° C. (dec.); ¹H NMR (CDCl₃, 250 MHz, SiMe₄, ppm): δ_{H} 8.56 (d, 1H, J=7.3 Hz, Hj), 8.49 (d, 1H, J=7.9 Hz, Hi), 8.37 (d, 1H, J=8.6 Hz, He), 7.65 (t, 1H, J=7.3 Hz, Hh), 7.19 (d, 1H, J=8.6 Hz, Hf), 5.11 (s, 2H, —CH₂ spacer), 4.50 (m, 2H, J=1.8 Hz, Cp), 4.20 (s, 5H, Cp), 4.07 (m, 2H, J=1.8 Hz, Cp), 3.28 (m, 4H, upper —CH2 methylpiperazine), 2.73 (m, 4H, lower —CH₂ methylpiperazine), 2.42 (s, 3H, —NCH3 methylpiperazine); ¹³C-NMR (62.9 MHz, CDCl₃, SiMe₄, ppm): δ_{C} 39.1, 46.1, 53.0, 55.2, 68.0, 68.6, 70.4, 83.4, 114.9, 116.8, 123.4, 125.6, 126.1, 129.9, 130.2, 131.1, 132.5, 155.9, 163.7, 164.2; vₘₐₓ (NaCl/cm⁻¹): 3088, 2929, 2837, 2787, 1691, 1654, 1589, 1577, 1558, 1516, 1452, 1419, 1386, 1373, 1334, 1288, 1244, 1139, 1105, 1006, 977, 785; UV-vis (MeOH) λₘₐₓ/nm (ε/cm⁻¹ mol L⁻¹): 399 (12700); UV-vis (1:1 MeOH/H₂O) λₘₐₓ/nm (ε/cm⁻¹ mol L⁻¹): 399 (12700).

2.3 Titration Procedure

The stock solution and the corresponding standard solutions for UV-visible and fluorimetric analysis were prepared in 1:1 (v/v). methanol:water. HPLC grade methanol and distilled water were used. A solution of compound 5 with a concentration 1×10⁻⁵ M yielded a UV-visible spectrum with an absorbance lower than 0.1 at 400 nm. The solution was diluted to a concentration of 3×10⁻⁶ M for the fluorescent studies. For the Fe(III) titration, the solution pH was adjusted to pH 3 using methanesulfonic acid. In both cases, the initial concentrations of the input solutions were sufficiently high so that only a minimum volume was added to solutions of compound 5. Solutions of Fe(III) were prepared by dissolving known amounts of iron(III) sulfate pentahydrate in water. The stock and standard solutions were prepared in grade A volumetric flasks. For volumes greater than 1 mL, the solutions of compound 5 and inputs were transferred using grade B pipettes. The transferring of accurate volumes smaller than 1 mL was possible by using Gilson pipetman classic pipettes.

2.4 Determination Of and Logic Functionality

The procedure for determining the two-input AND logic functionality consisted of preparing four solutions containing 3×10⁻⁶ M of 5 with the four possible input combinations. These solutions were prepared in 20 mL vials. The vials were labelled from A-D and in each one 10 mL of solution containing 5 were transferred. Vial A was kept neat without any input, to vial B a known volume of acid was added to obtain a solution with 0.2 mM H⁺, in vial C a known volume of oxidant was introduced to obtain a solution with 10 μM Fe(III) and in vial D both inputs were added with the same concentration as in vials B and C. The fluorescence of the solutions in the vials were observed with a UV lamp with 365 nm light (FIG. 7) and measured by a spectrofluorimeter using an excitation wavelength of 399 nm (FIG. 8).

2.5 Quantum Yields

The quantum yields of 5 under four different conditions were performed by comparing the fluorescence output with respect to a quantum yield standard. The reference standard was anthracene which has a fluorescence quantum yield of 0.27 in ethanol. The wavelength range was set to measure between 300-700 nm and the bandwidth of the light source was adjusted to 5 nm The measurements were carried out in 1:1 (v/v) methanol:water whilst ethanol was used for the standard anthracene.

The relative quantum yields have been determined via direct comparison of the wavelength integrated intensity of the unknown with respect to the standard. Equation (2) was used to obtain the quantum yields of fluorescence by relating the parameters and measurements of the both compound 5 and the standard,

$${Φ}_{F} = {Φ}_{STD} \times \frac{I}{{I}_{STD}} \times \frac{{OD}_{STD}}{OD} \times \frac{{n}^{2}}{{n}_{STD}^{2}} \qquad ( 2 )$$

where Φ_{F} and Φ_{STD} are the quantum yields for compound and standard. I, OD and n are values for the integrated fluorescent area, optical density and refractive index respectively. The standard reference values are identified by the subscript ‘STD’. A value of n=1.33 was used for the refractive index based on values for water and methanol of 1.3330 and 1.3284, respectively.

1. A method of measuring the acidity and redox potential of a sample, which method comprises:
(i) contacting a compound of formula (A) with the sample:
Acc(-L₁-)ₐFluo(-L₂-)_{b}Redox (A);
wherein:
Acc is a proton acceptor moiety;
Fluo is a fluorophore;
Redox is a redox unit;
each L₁ is a first spacer group which is bonded to Acc and Fluo;
each L₂ is a second spacer group which is bonded to Fluo and Redox;
a is 1 or 2; and
b is 1 or 2; and
(ii) exposing the sample to a light source, measuring fluorescence and thereby determining the acidity and redox potential of the sample.

2. A method according to claim 1, wherein the acid conjugate of Acc, Acc-H₊, has a pKₐ of greater than or equal to 0.

3. A method according to claim 2, wherein Acc comprises a group selected from a primary amine group, a secondary amine group, a tertiary amine group, a pyridine group, an imidazole group, a pyrrolidine group, a morpholine group, a piperazine group, a piperidine group, an azepane group, a thiomorpholine group, a 2H-pyrrole group, a 2-pyrroline group, a 3-pyrroline group, a 2-imidazoline group, an imidazolidine group, a 2-pyrazoline group, a pyrazolidine group, a 3H-indole group, an indoline group and a quinuclidine group.

4. A method according to claim 1, wherein Acc is a group selected from: 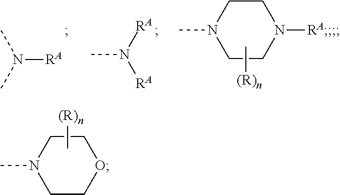
and;
wherein:
each R is independently a substituent selected from substituted or unsubstituted C₁₋₁₀ alkyl, substituted or unsubstituted C₂₋₁₀ alkenyl, substituted or unsubstituted C₂₋₁₀ alkynyl, substituted or unsubstituted aryl, substituted or unsubstituted heteroaryl, cyano, amino, nitro, substituted or unsubstituted C₁₋₁₀ alkylamino, substituted or unsubstituted di(C₁₋₁₀)alkylamino, substituted or unsubstituted arylamino, substituted or unsubstituted diarylamino, substituted or unsubstituted aryl(C₁₋₁₀)alkylamino, amido, acylamido, hydroxy, oxo, halo, carboxy, ester, acyl, acyloxy, substituted or unsubstituted C₁₋₁₀ alkoxy, substituted or unsubstituted aryloxy, halo(C₁₋₁₀)alkyl, sulfonic acid, thiol, substituted or unsubstituted C₁₋₁₀ alkylthio, arylthio, sulfonyl, phosphoric acid, phosphate ester, phosphonic acid and phosphonate ester;
each R_{A} is independently a substituent selected from H, substituted or unsubstituted C₁₋₈ alkyl and substituted or unsubstituted aryl, and where two R_{A} groups may be bonded together to form a substituted or unsubstituted C₁₋₈ alkylene group;
n is an integer from 0 to 4; and
each [symbol] represents a bond to an L₁.

5. A method according to claim 1, wherein Acc is a group selected from: 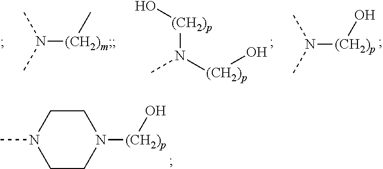
and;
wherein:
m is an integer from 0 to 7;
p is an integer from 1 to 8; and
each [symbol] represents a bond to an L₁.

6. A method according to claim 1, wherein Acc is a group selected from: 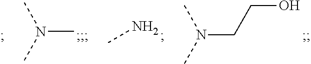
and;
wherein each [symbol] represents a bond to an L₁.

7. A method according to claim 1, wherein Fluo is a fluorophore selected from moieties of the following formulae: 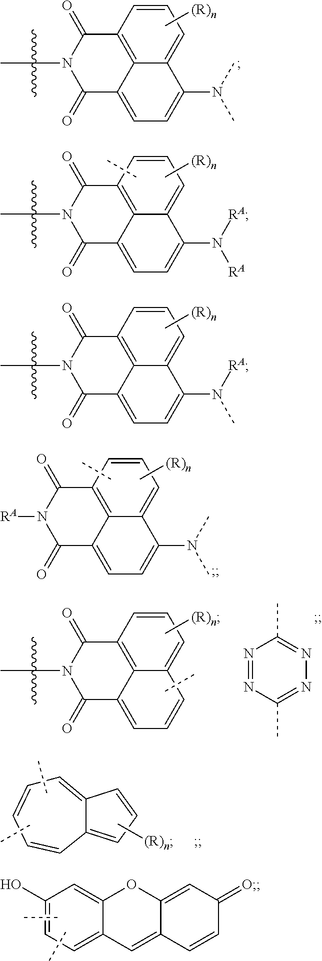 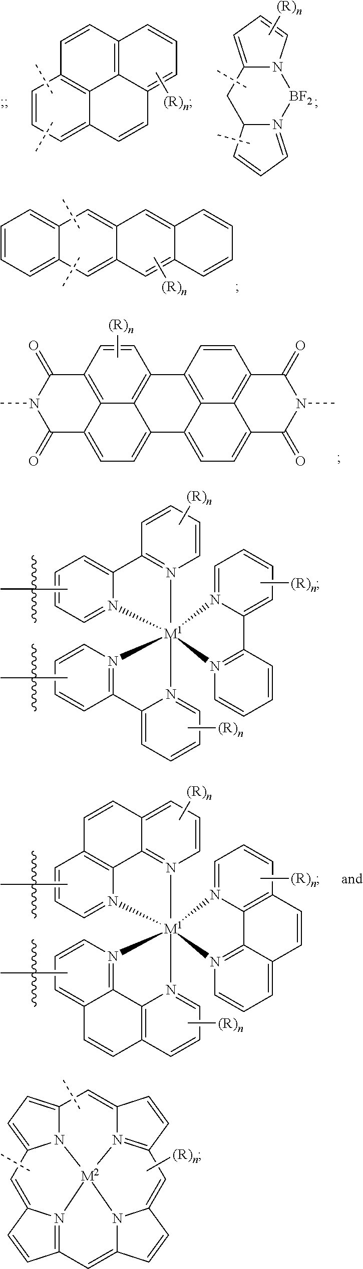
wherein:
each Q is independently N, NR₊, or CH;
each R is independently a substituent selected from substituted or unsubstituted C₁₋₁₀ alkyl, substituted or unsubstituted C₂₋₁₀ alkenyl, substituted or unsubstituted C₂₋₁₀ alkynyl, substituted or unsubstituted aryl, substituted or unsubstituted heteroaryl, cyano, amino, nitro, substituted or unsubstituted C₁₋₁₀ alkylamino, substituted or unsubstituted di(C₁₋₁₀)alkylamino, substituted or unsubstituted arylamino, substituted or unsubstituted diarylamino, substituted or unsubstituted aryl(C₁₋₁₀)alkylamino, amido, acylamido, hydroxy, oxo, halo, carboxy, ester, acyl, acyloxy, substituted or unsubstituted C₁₋₁₀ alkoxy, substituted or unsubstituted aryloxy, halo(C₁₋₁₀)alkyl, sulfonic acid, thiol, substituted or unsubstituted C₁₋₁₀ alkylthio, arylthio, sulfonyl, phosphoric acid, phosphate ester, phosphonic acid and phosphonate ester;
each R_{A} is independently a substituent selected from H, substituted or unsubstituted C₁₋₈ alkyl and substituted or unsubstituted aryl, and where two R_{A} groups may be bonded together to form a substituted or unsubstituted C₁₋₈ alkylene group;
M₁ is a metal atom;
M₂ is a metal atom;
n is an integer from 0 to 8; and
each [symbol] represents a bond to either an L₁ or an L₂.

8. A method according to claim 1, wherein Fluo is a fluorophore selected from moieties of the following formulae: 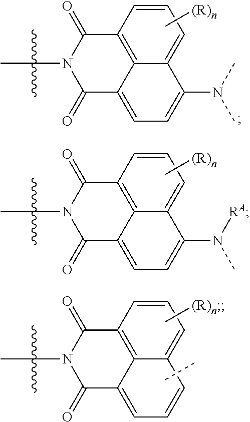
and;
wherein:
each R is independently a substituent selected from OH, NH₂, halo, unsubstituted C₁₋₈ alkyl, unsubstituted C₁₋₈ alkoxy, unsubstituted C₁₋₈ alkylamino, unsubstituted C₁₋₈ dialkylamino, unsubstituted C₁₋₈ monohydroxyalkyl and phenyl;
R_{A} is a substituent selected from H, unsubstituted C₁₋₈ alkyl, unsubstituted C₁₋₈ monohydroxyalkyl and phenyl;
n is an integer from 0 to 6; and
each [symbol] represents a bond to either an L₁ or an L₂.

9. A method according to claim 1, wherein Fluo is:
; or;
wherein:
R_{A} is a substituent selected from H, unsubstituted C₁₋₈ alkyl, unsubstituted C₁₋₈ monohydroxyalkyl and phenyl; and either
(a) [symbol] represents a bond to L₁ and each [symbol] * represents a bond to an L₂; or
(b) [symbol] represents a bond to L₂ and each [symbol] * represents a bond to an L₁.

10. A method according to any one of the proceeding claims, wherein Redox comprises a group selected from a quinone group, a catechol group, a metallocene group, a tetrathiafulvene group, a triarylamine group and a nitroxide group.

11. A method according to any one of the proceeding claims, wherein Redox is a redox unit selected from moieties of the following formulae: 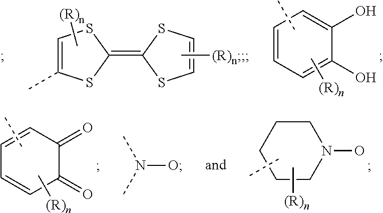
wherein:
each R is independently a substituent selected from substituted or unsubstituted C₁₋₁₀ alkyl, substituted or unsubstituted C₂₋₁₀ alkenyl, substituted or unsubstituted C₂₋₁₀ alkynyl, substituted or unsubstituted aryl, substituted or unsubstituted heteroaryl, cyano, amino, nitro, substituted or unsubstituted C₁₋₁₀ alkylamino, substituted or unsubstituted di(C₁₋₁₀)alkylamino, substituted or unsubstituted arylamino, substituted or unsubstituted diarylamino, substituted or unsubstituted aryl(C₁₋₁₀)alkylamino, amido, acylamido, hydroxy, oxo, halo, carboxy, ester, acyl, acyloxy, substituted or unsubstituted C₁₋₁₀ alkoxy, substituted or unsubstituted aryloxy, halo(C₁₋₁₀)alkyl, sulfonic acid, thiol, substituted or unsubstituted C₁₋₁₀ alkylthio, arylthio, sulfonyl, phosphoric acid, phosphate ester, phosphonic acid and phosphonate ester;
n is an integer from 0 to 8; and
each [symbol] represents a bond to an L₂.

12. A method according to claim 1, wherein Redox is a redox unit selected from moieties of the following formulae: 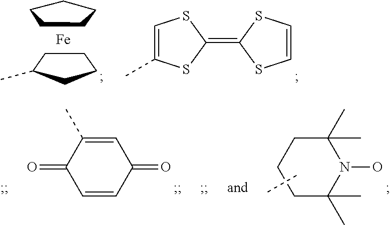
R_{A} is a substituent selected from H, unsubstituted C₁₋₈ alkyl, unsubstituted C₁₋₈ monohydroxyalkyl and phenyl; and
each [symbol] represents a bond to an L₂.

13. A method according to claim 1, wherein each L₁ and each L₂ are independently selected from a direct bond, a substituted or unsubstituted C₁₋₈ alkylene group, a substituted or unsubstituted C₄₋₁₂ cycloalkylene group, a substituted or unsubstituted arylene group and groups of formula -alk-ary-, -alk-ary-alk-, —O-alk-, —O-alk-O—, -alk-O-alk-, -alk-O-alk-O—, -alk-O-alk-O-alk-, —O-ary-,
-alk-O-ary, -alk-N(R_{A})—, -alk-N(R_{A})-alk-, -ary-N(R_{A})—, -alk-N(R_{A})-ary-, —C(O)—N(R_{A})-alk-, -alk-C(O)—N(R_{A})—, -alk-C(O)—N(R_{A})-alk-, —C(O)—O-alk-, -alk-C(O)—O—, -alk-C(O)—O-alk-, —C(O)-alk-, -alk-C(O)-alk-,
-alk-C(R_{A})═C(R_{A})—, -alk-C(R_{A})═C(R_{A})-alk-, -alk-C≡C—, and -alk-C≡C-alk-,
wherein:
alk is a substituted or unsubstituted C₋₄ alkylene group;
ary is a substituted or unsubstituted arylene group; and
each R_{A} is independently a substituent selected from H, substituted or unsubstituted C₁₋₈ alkyl and substituted or unsubstituted aryl.

14. A method according to claim 1, wherein each L₁ and each L₂ is independently selected from a substituted or unsubstituted C₁₋₄ alkylene group and a substituted or unsubstituted C₄₋₈ cycloalkylene group.

15. A method according to claim 1, wherein each L₁ and each L₂ is independently methylene, ethylene, propylene or butylene.

16. A method according to claim 1, wherein:
each L₁ is methylene or ethylene; and
each L₂ is methylene or ethylene.

17. A method according to claim 1, wherein the compound of formula (A) is of formula (B), (B2), (C), (D), (E) or (F): 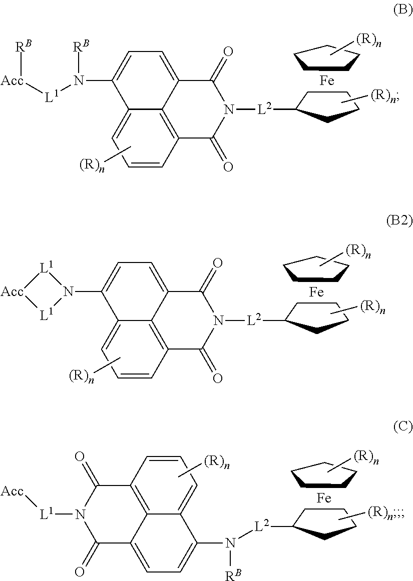
and;
wherein:
Acc is as defined in any one of claims 1 to 6;
each L₁ and each L₂ is as defined in any one of claims 1 and 13 to 16;
each R is independently a substituent selected from OH, NH₂, CN, NO₂, CF₃, OCH₃, halo, unsubstituted C₁₋₈ alkyl, unsubstituted C₁₋₈ alkoxy, unsubstituted C₁₋₈ alkylamino, unsubstituted C₁₋₈ dialkylamino, unsubstituted C₁₋₈ monohydroxyalkyl and phenyl;
R_{A} is a substituent selected from H, unsubstituted C₁₋₈ alkyl, unsubstituted C₁₋₈ monohydroxyalkyl and phenyl;
each R_{B} is independently a substituent selected from H, unsubstituted C₁₋₈ alkyl and unsubstituted C₁₋₈ monohydroxyalky, and where two R_{B} groups may be bonded together to form an unsubstituted C₁₋₄ alkylene group; and
n is an integer from 0 to 4.

18. A method according to claim 1, wherein the compound of formula (A) is of formula (G): 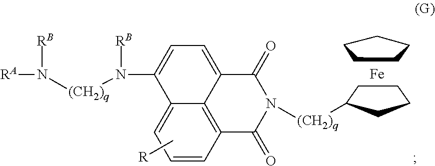
wherein:
R is a substituent selected from H, OH, NH₂, halo, unsubstituted C₁₋₈ alkyl, unsubstituted C₁₋₈ alkoxy, unsubstituted C₁₋₈ alkylamino, unsubstituted C₁₋₈ dialkylamino, unsubstituted C₁₋₈ monohydroxyalkyl and phenyl;
R_{A} is a substituent selected from H, unsubstituted C₁₋₈ alkyl, unsubstituted C₁₋₈ monohydroxyalkyl and phenyl;
each R_{B} is independently a substituent selected from H, unsubstituted C₁₋₈ alkyl and unsubstituted C₁₋₈ monohydroxyalky, and where the two R_{B} groups may be bonded together to form an unsubstituted C₁₋₄ alkylene group; and
each q is independently 1, 2 or 3.

19. A method according to claim 1, wherein the compound of formula (A) is of formula (H), (I) or (J): 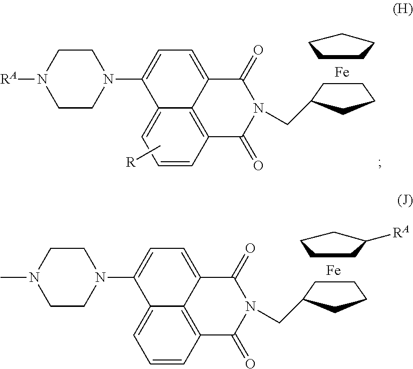
wherein:
R is a substituent selected from H, OH, NH₂, halo, unsubstituted C₁₋₈ alkyl, unsubstituted C₁₋₈ alkoxy, unsubstituted C₁₋₈ alkylamino, unsubstituted C₁₋₈ dialkylamino, unsubstituted C₁₋₈ monohydroxyalkyl and phenyl; and
R_{A} is a substituent selected from H, unsubstituted C₁₋₈ alkyl, unsubstituted C₁₋₈ monohydroxyalkyl and phenyl.

20. A method according to claim 1, wherein the compound of formula (A) is attached to a solid support.

21. A method according to claim 1, wherein step (i) of contacting a compound of formula (A) with the sample comprises forming a composition comprising the sample and the compound of formula (A), wherein the concentration of the compound of formula (A) in the sample is from 0.1 μM to 10 mM.

22. A method according to claim 1, wherein the sample comprises greater than or equal to 20% of water by weight relative to the total weight of the sample.

23. A method according to claim 1, wherein step (ii) comprises exposing the sample to said light source, measuring the intensity of the fluorescence, comparing the intensity of the fluorescence to a reference value, and determining that the pH of the sample is below a pH threshold value and that the redox potential of the sample is above a pE threshold value if the measured intensity of the fluorescence exceeds the reference value.

24. A method according to claim 1, wherein step (ii) comprises exposing the sample to said light source, observing the presence or absence of fluorescence and determining that the pH of the sample is below a pH threshold value and that the redox potential of the sample is above a pE threshold value if fluorescence is present.

25. A method according to claim 24, wherein said pH threshold value is a pH value of less than or equal to 6.6 and said pE threshold value is a E value of greater than or equal to 0.4 V (or pE greater than or equal to 6.8), preferably wherein said pH threshold value is a value of from 0.5 to 6.0 and said pE threshold value is a value from 6 to 25 (0.4V to 1.5V).

26. A compound of formula (A):
Acc(-L₁-)ₐFluo(-L₂-)_{b}Redox (A);
wherein:
Acc is a proton acceptor moiety;
Fluo is a fluorophore;
Redox is a redox unit;
each L₁ is a first spacer group which is bonded to Acc and Fluo;
each L₂ is a second spacer group which is bonded to Fluo and Redox;
a is 1 or 2; and
b is 1 or 2.

27. (canceled)

28. A compound according to claim 26, wherein the compound of formula (A) is of formula (H), (I) and (J): 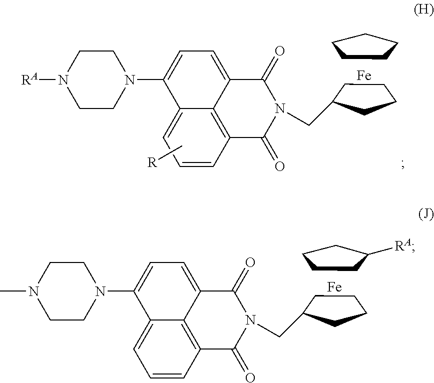
wherein:
R is a substituent selected from H, OH, NH₂, NO₂, halo, unsubstituted C₁₋₈ alkyl, unsubstituted C₁₋₈ alkoxy, unsubstituted C₁₋₈ alkylamino, unsubstituted C₁₋₈ dialkylamino, unsubstituted C₁₋₈ monohydroxyalkyl and phenyl; and
R_{A} is a substituent selected from H, unsubstituted C₁₋₈ alkyl, unsubstituted C₁₋₈ monohydroxyalkyl and phenyl.

29. A compound according to claim 26, wherein use of a compound of formula (A) for measuring the acidity and redox potential in a sample:
Acc(-L₁-)ₐFluo(-L₂-)_{b}Redox (A);
wherein:
Acc is a proton acceptor moiety;
Fluo is a fluorophore;
Redox is a redox unit;
each L₁ is a first spacer group which is bonded to Acc and Fluo;
each L₂ is a second spacer group which is bonded to Fluo and Redox;
a is 1 or 2; and
b is 1 or 2.

30. (canceled)
